(19) United States
(12) Patent Application Publication
(10) Pub. No.: US 2002/0002709 A1
(43) Pub. Date: Jan. 3, 2002

(54) Method and system for transmitting multimedia data with downstream data transfer over local TV broadcasting channel and for receiving request with upstream data transfer over another channel

(76) Inventor: Young-Sang An, Seoul (KR)

Correspondence Address: MARSHALL, O'TOOLE, GERSTEIN, MURRAY & BORUN, 6300 SEARS TOWER, 233 SOUTH WACKER DRIVE, CHICAGO, IL, 60606-6402, US

(21) Appl. No.: 09/820,238

(22) Filed: Mar. 28, 2001

(30) Foreign Application Priority Data
Mar. 28, 2000 (KR) 2000-0015857
Oct. 12, 2000 (KR) 2000-0060021

(51) Int. Cl. H04N 7/173

(52) U.S. Cl. 725/109; 725/111; 725/122

(57) ABSTRACT

A communication system for propagating multimedia data through local TV broadcasting channel as downstream data transfer to a plurality of customer premise equipment, and for receiving at least one customer's request through telephone network as upstream data transfer is provided.

The communication system includes a broadcasting control center for receiving at least one customer's request from at least one customer premise, and for transmitting broadcasting applying signal to a local broadcasting center corresponding to a customer's request; and at least one local broadcasting center coupled to said broadcasting control center and the plurality of customer premise equipment, for propagating multimedia data corresponding to the customer's request through local TV broadcasting channels to the plurality of customer premise equipment corresponding to the broadcasting applying signal received from said broadcasting control center.

### FIELD OF THE INVENTION

The present invention relates generally to a data communication method and system and, in particular, to a method and system for communicating multimedia data with downstream data transfer over a local TV broadcasting channel to plurality of customer premise equipments and with upstream data transfer over another channel.

### BACKGROUND OF THE INVENTION

In the past, multicast data communication services and networks, which are capable of transmitting multimedia data such as audio data or video data, had not been constructed. Consequently, a plurality of users could not receive multimedia data at high speed.

However, communication technology has developed rapidly and the desires of users have increased in pace with that development. In recent years, users have been able to receive multimedia data via Internet services. Moreover, broadband, multi-channel, and interactive services have been possible. So, users have been able to see and hear TV broadcasting signals via fast Internet services.

However, in the case of using a PSTN (Public Switched Telephone Network) with 33.6 Kbps or 56 Kbps speed or an ISDN (Integrated Service Digital Network) with 128 Kbps speed, the real time transfer of text data, audio data, graphic data or video data is actually difficult. Therefore, cable TV service providers have entered the Internet or telephone communications market, becoming combined broadcasting services and communication services. So, users can receive multimedia data in real time and VOD (Video On Demand) services capable of receiving any specified multimedia data demanded by the public.

One representative multimedia data service is the CATV (Cable TV) transferring system, which uses optical cables or coaxial cables as data transferring media. A CATV transferring system that operates as an integrated wired TV service may be roughly divided into a data communication service and a multi-channel video service. In order to use these services, CATV subscribers must have a personal computer and they must be located within the range of the CATV system's communication. These are essential conditions for using CATV services.

A schematic diagram illustrating an example of a prior CATV system is shown in FIG. 1.

With reference to FIG. 1, a CATV system consists of a CATV service subscriber center 10 for receiving multimedia data through a CATV network 2 and a multimedia data distribution center 20 for transmitting multimedia data to a plurality of CATV service subscriber centers 10.

The CATV service subscriber center 10 may include a computer system 11 and a TV 15. The computer system 11 receives multimedia data at high speed from the CATV network 2 through a splitter 13 and a cable modem 12. The cable modem 12 converts the CATV radio frequency (RF) signal received from the CATV network 2 to a Local Area Network (LAN) signal, and provides the LAN signal to the computer system 11.

On the other hand, the cable modem 12 converts the LAN signal received from the computer system 11 to a CATV radio frequency signal, and provides the CATV radio frequency signal to the CATV network 2 through the splitter 13. Therefore, the cable modem 12 carries out various functions such as data modulation and demodulation, tuning, bridging and routing. The cable modem 12 may be coupled to a LAN card in the computer system 11 through a LAN cable linked to the connector of a LAN transceiver.

Generally, the downstream data transmission rate from the multimedia data distribution center 20 to the CATV service subscriber 10 ranges from 10 Mbps to 40 Mbps. Upstream data transmission rate from the CATV service subscriber 10 to the multimedia data distribution center 20 range from 2 Mbps to 10 Mbps.

A subscriber can see and hear video data transmitted from the CATV network 2 with a TV 15 coupled to a set top box (STB) 14. The set top box 14 is a communication terminal device for using an interactive multimedia data service (or interactive TV service), such as for providing video on demand, home shopping services, and network games. A digital set top box is a terminal device enabling users to see and hear digital broadcasting signals with an analog TV, and an external set top box is used for taking advantage of the Internet through a connection to an ordinary TV. In other words, the set top box 14 plays the role of a converter for converting received digital signals to analog signals that can be shown on the screen of an analog TV 15. The name of set top box 14 is generated from meaning of using it on the TV 15 and it comes into use for designating specified product in advanced concept.

The multimedia data distribution center 20 consists of a data channel controller 23, a signal distributor 22, a frequency converter 24 and a cable router 21.

The data channel controller 23 transmits periodic reference signals or high-speed multimedia data to a cable modem 12 through a CATV network 2. The data channel controller 23 provides an upstream data signal, which is transmitted from the cable modem 12, to Internet 4 through the cable router 21. In general, the data channel controller 23 converts a CATV downstream data signal with a 6 MHz transmission rate to a digital signal with a transmission rate ranging between 4 Mbps and 30 Mbps. It also converts a digital signal with a transmission rate ranging from 500 Kbps to 10 Mbps into a CATV upstream data signal with a transmission rate of 6 Mbps.

The signal distributor 22 provides an upstream data signal, which is transmitted through the CATV network 2, to the frequency converter 24. The frequency converter 24 converts the frequency of the upstream data signal, and then the signal distributor 22 provides the frequency-converted upstream data signal to the data channel controller 23. Also, the signal distributor 22 receives the CATV downstream data signal from the data channel controller 23 and provides it to the frequency converter 24. The frequency converter 24 converts the frequency of the CATV downstream data signal, and then the signal distributor 22 provides the frequency-converted CATV downstream data signal to the CATV service subscriber center 10 through the CATV network 2. Preferably, the frequency converter 24 may control frequencies in units of 250 KHz for using multi-channel.

By supporting optical communication and new media technology, the CATV system can provide interactive communication services. Also, the CATV system has the advantage of providing various kinds of services, such as home shopping, home banking, as well as local information. Furthermore, the CATV system may be understood as a dream channel because a wide variety of services are possible, such as crime prevention, water rate checking, remote medical diagnosis, and all kinds of useful information.

In short, the multi-channel video service is a service capable of broadcasting various TV programs, such as movies, educational programs, entertainment programs, and programs related to recreation and sports. The multi-channel video service center provides various programs to a plurality of subscriber centers connected with a TV program provider and CATV broadcasting center.

A CATV network 2 may be mainly composed of hybrid fiber coaxial (HFC) cable, which is with a combination of optical cable and coaxial cable. HFC cable is used for the CATV services, but at present it may be used for high-speed Internet services. High-speed Internet services do not use telephone lines, so subscribers can use the telephone and the Internet simultaneously. Also, Internet services use a different bandwidth than CATV services, so using them does not have any influence upon a TV's signal reception. Internet services using a CATV network 2 generally have high speed, e.g., a 10 Mbps download rate, so it is possible to transmit large volumes of multimedia data in a short time, to broadcast real-time video data, and to provide services such as video conferencing.

However, it is possible to use a CATV service only in the service area in which the CATV network is constructed. Because cable modems have not yet become standardized, data transmission rates vary according to the kind of modem used and the user's connection.

Prior art solutions to improve data transmission rates have included providing wide bandwidths and the high-speed data transmissions found in a cable television infrastructure.

In U.S. Pat. No. 5,534,913, issued Jul. 9, 1996, entitled “Apparatus and Method for Integrating Downstream Data Transfer Over a Cable Television Channel with Upstream Data Carrier by Other Media” a telecommunication network is disclosed that utilizes high-speed, cable transmission channels to transport information on a downstream channel from an information service provider to a user's customer premises equipment.

In U.S. Pat. No. 6,141,682, issued Oct. 31, 2000, entitled “Method and Apparatus for Integrating Interactive Local Internet Access and Downstream Data Transfer Over a Cable TV System With Upstream Data Carried By Other Media” a data communication system is disclosed that utilizes high bandwidth channels to transmit information on a downstream channel from an information service provider and interactive data service provider to a user's customer premise equipment.

FIG. 2 illustrates a conventional telecommunication system with downstream data transfer over a cable television channel and upstream data transfer by other media.

With reference to FIG. 2, a conventional telecommunication system uses a cable television infrastructure for communicating between information service providers 90A-90N a user's customer premise equipment 80. Generally, information service providers 90A-90N communicate with the user's customer premise equipment 80 over the high-speed communication channels 92 of a telecommunication network 94.

Communication is initiated between the user's customer premise equipment 80 and one of the information service providers 90A-90N when the user makes a request for information. The user employs, for example, a personal computer system 74 of the user's customer premise equipment 80 in order to make a request for information. The personal computer system 74 includes a modem 76 which is coupled to a public switched telephone network (PSTN) 84 through a communication channel 82. The request is routed by a split channel bridging unit 98 over a high-speed, bi-directional communication channel 96 and the telecommunication network 94 to a specified information service providers 90A-90N.

In response to the request, the specified one of the information service providers 90A-90N transmits the requested information back through the telecommunication network 94 and the high-speed, bi-directional communication network 96 to the split channel bridging unit 98. The split channel bridging unit 98 routes the requested information to one of a plurality of cable distribution head ends 30A-30N. One of the plurality of cable distribution head ends 30A-30N provides a service to the user's customer premise equipment 80. Therefore, the split channel bridging unit 98 routes the requested information to an associated one of a plurality of cable distribution head ends 30A-30N. The cable distribution head end 30A-30N associated with the user's request distributes the requested information to the user's customer premise equipment 80 over cable communication channels 36.

In this way, the personal computer system 74 of the user making the request receives information over the cable television system at substantially higher transmission rates than would be realized if the information was transmitted over the relatively low-speed data channels of a PSTN 84, which uses a dial-up modem.

Communication from a requesting user's customer premise equipment 80 to a specified one of the information service providers 90A-90N is referred to as communication along an upstream communication path. Correspondingly, communication from a specified information service provider 90A-90N to the user's customer premise equipment 80 is referred to as communication along a downstream communication path.

FIG. 3 illustrates another conventional telecommunication system with downstream data transfer over a cable television channel and upstream data transfer by means of other media.

With reference to FIG. 3, conventional telecommunication systems have one upstream communication path and another downstream communication path. Also, an interactive data service provider coupled to one end of the downstream communication path can be accessed locally in order to enhance data transmission rates.

A conventional telecommunication system may utilize a cable television infrastructure to communicate between information service providers and a user's customer premise equipment 150. However, information service providers may be coupled at one end of an upstream communication path, e.g., information service providers 152A-152N, and on a downstream communication path, e.g., information service providers 154A-154N. A user requesting information services transmits a request for information from, for example, a personal computer system 164 within the user's customer premise equipment 150. The request is received by one of a plurality of modems 172A-172N coupled to a PSTN 168 through a communication channel 174A-174N.

The user's request for information also specifies the type of information requested. Depending upon the type of information requested, the communication controller 176 routes the user's request for information to a selected one among a plurality of information service providers 152A-152N coupled at the end of the upstream communication path or a selected one among numerous interactive data service providers 154A-154N coupled on the downstream communication path.

The requested information received from the selected one of the information service providers 152A-152N is passed by the receiver 184 over communication channel 186 to the first input 188a of a channel combiner 188. A request for interactive data services is passed by the communication controller 176 over a communication channel 180 to the second input 188b of the channel combiner 188. The first input and the second input are multiplexed by the channel combiner 188 to provide a multiplexed signal which includes the requested information received from the selected one of the information service providers 152A-152N and the request for interactive data services from the communication controller 176. The multiplexed signal is outputted by the channel combiner 188 and transmitted on one of the cable transmission channels, e.g., cable transmission channel 190, of the downstream communication path to one of a plurality of cable distribution devices 192A-192N.

One of a plurality of cable distribution devices 192A-192N serves one of a plurality of user's customer premise equipment 150. The user's premise equipment 150 is served by the particular cable distribution devices 192A-192N associated with it. However, the user's customer premise equipment must include a computer system, a cable modem and a set top box for using a CATV network. Moreover, in order to use CATV services, the user must reside within the CATV service area. Also, the user must purchase some expensive devices, e.g., a cable modem or set top box, in order to use CATV services.

On the other hand, the information requested by the user may be of various types, ranging from small amounts of data, e.g., music files or information for home shopping, to lengthy media files, e.g., movies, educational programs, entertainment programs, and sports broadcasts. Typically, the kinds of information that consist of small amounts of data are useful in neighborhoods where people have interests similar to those of the user, so it is efficient to provide the requested information simultaneously to a plurality of users residing in a specified area.

There is particularly a need for a method and apparatus which employs a local broadcasting distribution network to provide requested information over local broadcasting channels as a downstream communication path while also allowing localized access over an upstream communication path.

### SUMMARY OF THE INVENTION

It is a first object of this invention to provide a communication system that employs a local TV broadcasting channel as a downstream data transfer to provide multimedia data, and which also allows requests for multimedia data to be made to the broadcasting control center over another channel as upstream data transfer.

It is another object of this invention to provide a communication system that employs a local TV broadcasting channel instead of a cable distribution channel to provide multimedia data simultaneously to the plurality of customer premise equipments in a limited neighboring area, and which allows requests for multimedia data to be made without the cable modem and set top box usually used by cable distribution networks.

It is another object of this invention to provide a communication system that employs a broadcasting server in the local broadcasting center to provide multimedia data to the plurality of customer premise equipment within limited service area and which improves the efficiency of the data transmission rate.

To achieve the above-mentioned objects of the present invention, it is provided communication system for transmitting multimedia data with downstream data transfer over local distribution channel for TV broadcasting to a plurality of customer premise equipments and with upstream data transfer over telecommunication channel for user's request from at least one of the customer premise equipments. The communication system includes a broadcasting control center for receiving user's request from the customer premise equipment through the upstream telecommunication channel and for transmitting broadcast applying signal to the specified local broadcasting center in accordance with the received user's request, and at least one of local broadcasting center coupled to said broadcasting center and said plurality of the customer premise equipments, for propagating requested multimedia data through the local distribution channel for TV broadcasting to the plurality of the customer premise equipments in specified service area in accordance with the broadcast applying signal from the broadcasting control center.

The telecommunication channel further includes automatic response service (ARS) system.

The broadcasting control center includes a database for keeping in store user's private information, summary of multimedia data and broadcasting information of the local broadcasting centers, an ARS server for receiving user's request and providing service comments to the customer premise equipment through telecommunication channel, and a controller for providing broadcast applying signal to the specified local broadcasting center coupled to said customer premise equipment, said broadcast applying signal comprising said user's private information, summary of the multimedia data and the broadcasting information of the specified local broadcasting center.

The broadcasting information includes at least one of code of local broadcasting center, local area code, and code of local distribution channel for TV broadcasting.

The summary of the multimedia data includes code assigned to requested multimedia data.

The broadcast applying signal includes transmission code, response code, request code, multimedia data code and checksum code, wherein said transmission code comprising transmission date and transmission time, said response code for certificating arrival of the broadcast applying signal, said request code comprising request data and request time, said checksum code for checking error of transmisson.

The controller includes a router for receiving multimedia data from information service provider (ISP) through internet and a multimedia processor for giving a code for one multimedia data, storing the code of multimedia data and providing the multimedia data to the plurality of local broadcasting centers.

The plurality of local broadcasting centers include a database for keeping in store multimedia data to be broadcasting through local distribution channel for TV broadcasting, a receiver for receiving the broadcast applying signal from the broadcasting control center, a schedule manager for detecting requested multimedia data from the database according to the broadcast applying signal and for controlling the broadcasting time of the detected multimedia data, a converter for converting digital multimedia data detected from the database to analog multimedia data, a caption editor for generating analog broadcasting signal with added caption data, said caption data are displayed on the TV in customer premise equipment and a propagation controller for controlling the transmission of the analog broadcasting signal to plurality of customer premise equipments in specified service area through local distribution channel for TV broadcasting.

The schedule manager further includes a buffer for storing the broadcasting signal temporarily for propagating through the local distribution channel of TV broadcasting in order of requests.

The caption data includes at least one of ARS phone number, local area code, local broadcasting center code, TV channel code, serviceable multimedia data code, multimedia data code in standing-by and playing time of multimedia data in standing-by.

The local broadcasting center includes at least one of broadcasting monitor for checking screen condition and transmission error of multimedia data propagated to plurality of customer premise equipments.

Also, to achieve the above-mentioned objects of the present invention, it is provided method for communicating multimedia data with downstream data transfer over local distribution channel for TV broadcasting to a plurality of customer premise equipments and with upstream data transfer over telecommunication channel for user's request from at least one of the customer premise equipments. The method of communicating multimedia data includes the steps of: (a) keeping multimedia data for transmitting through the local distribution channel for TV broadcasting in the database of plurality of local broadcasting centers, respectively; (b) keeping summary of multimedia data in the database of broadcasting control center, said summary reflecting specified multimedia data in local broadcasting centers; (c) receiving user's request from the customer premise equipment through the upstream telecommunication channel; (d) generating broadcast applying signal according to the user's request, said broadcast applying signal is comprised of at least one of user's private information, summary of multimedia data and summary of local broadcasting center; (e) transmitting said broadcast applying signal to the specified local broadcasting center; (f) detecting requested multimedia data from database in local broadcasting center according to the broadcast applying signal; (g) converting detected digital multimedia data to analog broadcasting signal for providing through local distribution channel of TV broadcasting; and (g) propagating the analog broadcasting signal to the plurality of customer premise equipment in limited service area.

The summary of local broadcasting center includes at least one of code of local broadcasting center, local area code, and TV channel code in capable of transmitting broadcasting signal.

The summary of multimedia data includes code for assigning requested multimedia data.

The broadcast applying signal includes transmission code, response code, request code, multimedia data assigning code and checksum code, wherein said transmission code comprising transmission date and transmission time, said response code for certificating arrival of the broadcast applying signal, said request code comprising request data and request time, said checksum code for checking error of transmission.

The step of converting detected digital multimedia data to analog broadcasting signal for providing through local distribution channel for TV broadcasting further includes the step of adding caption data to the analog broadcasting signal, wherein said caption data are displayed on TV screen of customer premise equipment.

The caption data include at least one of ARS phone number, local area code, local broadcasting center code, TV channel code, serviceable multimedia data code, multimedia data code in standing-by and playing time of multimedia data in standing-by.

Also, to achieve the above-mentioned objects of the present invention, it is provided communication system for providing broadcast applying signal to the specified local broadcasting center, said broadcast applying signal is for applying propagation of multimedia data with downstream data transfer over local distribution channel for TV broadcasting to a plurality of customer premise equipments, and for receiving user's request with upstream data transfer over telecommunication channel from at least one of the customer premise equipments. The communication system includes a database for keeping in store user's private information, summary of multimedia data and broadcasting information of the local broadcasting centers, an ARS server for receiving user's request and providing service comments to the customer premise equipment through telecommunication channel, a generator for generating broadcast applying signal which is comprised of at least one of user's private information, summary of the multimedia data and the broadcasting information of the specified local broadcasting center, and a transmitter for transmitting the broadcast applying signal to the specified local broadcasting center governing the user's customer premise equipment having requested multimedia data.

Also, to achieve the above-mentioned objects of the present invention, it is provided method for providing broadcast applying signal to the specified local broadcasting center, said broadcast applying signal is for applying propagation of multimedia data with downstream data transfer over local distribution channel for TV broadcasting to a plurality of customer premise equipments, and for receiving user's request with upstream data transfer over telecommunication channel from at least one of the customer premise equipments. The method of providing broadcast applying signal includes the steps of: (a) keeping in store summary of multimedia data and summary of the plurality of local broadcasting centers, wherein said multimedia data are stored in the plurality of the local broadcasting centers, respectively, (b) receiving user's request from customer premise equipment through telecommunication channel; (c) generating broadcast applying signal which is comprised of at least one of user's private information, summary of the multimedia data and the broadcasting information of the specified local broadcasting center; and (d) transmitting the broadcast applying signal to the specified local broadcasting center governing the user's customer premise equipment having requested multimedia data.

Also, to achieve the above-mentioned objects of the present invention, it is provided communication system for propagating multimedia data with downstream data transfer over local distribution channel for TV broadcasting to a plurality of customer premise equipments according to user's request with upstream data transfer over communication channel from at least one of the customer premise equipments. The communication system includes a database for keeping in store multimedia data to be broadcasting through local distribution channel for TV broadcasting, a receiver for receiving the broadcast applying signal from the broadcasting control center, wherein said broadcast applying signal is comprised of at least one of user's private information, summary of the multimedia data and the broadcasting information of the specified local broadcasting center, a schedule manager for detecting requested multimedia data from the database according to the broadcast applying signal and for controlling the broadcasting time of the detected multimedia data, a converter for converting digital multimedia data detected from the database to analog multimedia data, a caption editor for generating analog broadcasting signal with added caption data, said caption data are displayed on the TV in customer premise equipment, and a propagation controller for controlling the transmission of the analog broadcasting signal to plurality of customer premise equipments in specified service area through local distribution channel for TV broadcasting.

Also, to achieve the above-mentioned objects of the present invention, it is provided method for propagating multimedia data with downstream data transfer over local distribution channel for TV broadcasting to a plurality of customer premise equipments according to user's request with upstream data transfer over communication channel from at least one of the customer premise equipments. The method for propagating multimedia data includes the steps of: (a) keeping in store multimedia data to be broadcasting through local distribution channel for TV broadcasting; (b) receiving the broadcast applying signal from the broadcasting control center, wherein said broadcast applying signal is comprised of at least one of user's private information, summary of the multimedia data and the broadcasting information of the specified local broadcasting center; (c) detecting requested digital multimedia data from the database; (d) converting digital multimedia data detected from the database to analog multimedia data; (e) generating analog broadcasting signal with added caption data, said caption data are displayed on the TV in customer premise equipment; and (f) propagating the analog broadcasting signal to plurality of customer premise equipments in specified service area through local distribution channel for TV broadcasting according to broadcasting schedule.

Also, to achieve the above-mentioned objects of the present invention, it is provided communication system for transmitting multimedia data with downstream data transfer over local distribution channel for TV broadcasting to a plurality of customer premise equipments and with upstream data transfer over internet for user's request from at least one of the customer premise equipments. The communication system includes a broadcasting control center for receiving user's request from the customer premise equipment through internet as upstream communication channel and for transmitting broadcast applying signal to the specified local broadcasting center in accordance with the received user's request, and at least one of local broadcasting center coupled to said broadcasting center and said plurality of the customer premise equipments, for propagating requested multimedia data through the local distribution channel for TV broadcasting to the plurality of the customer premise equipments in specified service area in accordance with the broadcast applying signal from the broadcasting control center.

Also, to achieve the above-mentioned objects of the present invention, it is provided method for communicating multimedia data with downstream data transfer over local distribution channel for TV broadcasting to a plurality of customer premise equipments and with upstream data transfer over internet for user's request from at least one of the customer premise equipments. The method for communicating multimedia data includes the steps of: (a) keeping multimedia data having object to propagate through the local distribution channel for TV broadcasting in the database of plurality of local broadcasting centers, respectively; (b) keeping summary of multimedia data in the database of broadcasting control center, said summary reflecting specified multimedia data in local broadcasting centers; (c) receiving user's request from the customer premise equipment through the internet as upstream communication channel; (d) generating broadcast applying signal according to the user's request, said broadcast applying signal is comprised of at least one of user's private information, summary of multimedia data and summary of local broadcasting center; (e) transmitting said broadcast applying signal to the specified local broadcasting center; (f) detecting requested multimedia data from database in local broadcasting center according to the broadcast applying signal; (g) converting detected digital multimedia data to analog broadcasting signal for providing through local distribution channel of TV broadcasting; and (h) propagating the analog broadcasting signal to the plurality of customer premise equipment in limited service area.

Also, to achieve the above-mentioned objects of the present invention, it is provided a computer-readable medium having computer readable code stored therein, for accomplishing method of communicating multimedia data with downstream data transfer over local distribution channel for TV broadcasting to a plurality of customer premise equipments and with upstream data transfer over telecommunication channel for user's request from at least one of the customer premise equipments. The computer-readable medium includes a first keeping module for storing multimedia data for transmitting through the local distribution channel for TV broadcasting in the database of plurality of local broadcasting centers, respectively, a second keeping module for storing summary of multimedia data in the database of broadcasting control center, said summary reflecting specified multimedia data in local broadcasting centers, a receiving module for receiving user's request from the customer premise equipment through the upstream telecommunication channel, a generating module for generating broadcast applying signal according to the user's request, said broadcast applying signal is comprised of at least one of user's private information, summary of multimedia data and summary of local broadcasting center, a transmitting module for providing said broadcast applying signal to the specified local broadcasting center, a detecting module for detecting requested multimedia data from database in local broadcasting center according to the broadcast applying signal, a converting module for converting detected digital multimedia data to analog broadcasting signal for providing through local distribution channel of TV broadcasting, and a propagating module for propagating the analog broadcasting signal to the plurality of customer premise equipment in limited service area.

Also, to achieve the above-mentioned objects of the present invention, it is provided a computer-readable medium having computer readable code stored therein, for accomplishing method of providing broadcast applying signal to the specified local broadcasting center, said broadcast applying signal is for applying propagation of multimedia data with downstream data transfer over local distribution channel for TV broadcasting to a plurality of customer premise equipments, and for receiving user's request with upstream data transfer over telecommunication channel from at least one of the customer premise equipments. The computer-readable medium includes a keeping module for storing summary of multimedia data and summary of the plurality of local broadcasting centers, wherein said multimedia data are stored in the plurality of the local broadcasting centers, respectively, a receiving module for receiving user's request from customer premise equipment through telecommunication channel, a generating module for generating broadcast applying signal which is comprised of at least one of user's private information, summary of the multimedia data and the broadcasting information of the specified local broadcasting center, and a transmitting module for transmitting the broadcast applying signal to the specified local broadcasting center governing the user's customer premise equipment having requested multimedia data.

Also, to achieve the above-mentioned objects of the present invention, it is provided a computer-readable medium having computer readable code stored therein, for accomplishing method of propagating multimedia data with downstream data transfer over local distribution channel for TV broadcasting to a plurality of customer premise equipments according to user's request with upstream data transfer over communication channel from at least one of the customer premise equipments. The computer-readable medium includes a keeping module for storing multimedia data to be broadcasting through local distribution channel for TV broadcasting, a receiving module for receiving the broadcast applying signal from the broadcasting control center, wherein said broadcast applying signal is comprised of at least one of user's private information, summary of the multimedia data and the broadcasting information of the specified local broadcasting center, a detecting module for detecting requested digital multimedia data from the database, a converting module for converting digital multimedia data detected from the database to analog multimedia data, a broadcasting signal generating module for generating analog broadcasting signal with added caption data, said caption data are displayed on the TV in customer premise equipment, and a propagating module for propagating the analog broadcasting signal to plurality of customer premise equipments in specified service area through local distribution channel for TV broadcasting according to broadcasting schedule.

Also, to achieve the above-mentioned objects of the present invention, it is provided a computer-readable medium having computer readable code stored therein, for accomplishing method for communicating multimedia data with downstream data transfer over local distribution channel for TV broadcasting to a plurality of customer premise equipments and with upstream data transfer over internet for user's request from at least one of the customer premise equipments. The computer-readable medium includes a first keeping module for storing multimedia data having object to propagate through the local distribution channel for TV broadcasting in the database of plurality of local broadcasting centers, respectively, a second keeping module for storing summary of multimedia data in the database of broadcasting control center, said summary reflecting specified multimedia data in local broadcasting centers, a receiving module for receiving user's request from the customer premise equipment through the internet as upstream communication channel, a generating module for generating broadcast applying signal according to the user's request, said broadcast applying signal is comprised of at least one of user's private information, summary of multimedia data and summary of local broadcasting center, a transmitting module for providing said broadcast applying signal to the specified local broadcasting center, a detecting module for detecting requested multimedia data from database in local broadcasting center according to the broadcast applying signal, a converting module for converting detected digital multimedia data to analog broadcasting signal for providing through local distribution channel of TV broadcasting, and a broadcasting signal propagating module for propagating the analog broadcasting signal to the plurality of customer premise equipment in limited service area.

### BRIEF DESCRIPTION OF THE DRAWINGS

A full understanding of this invention can be gained from the following description of the preferred embodiments when they are read in conjunction with the accompanying drawings, in which:

FIG. 1 is a schematic diagram illustrating an example of a prior CATV system;

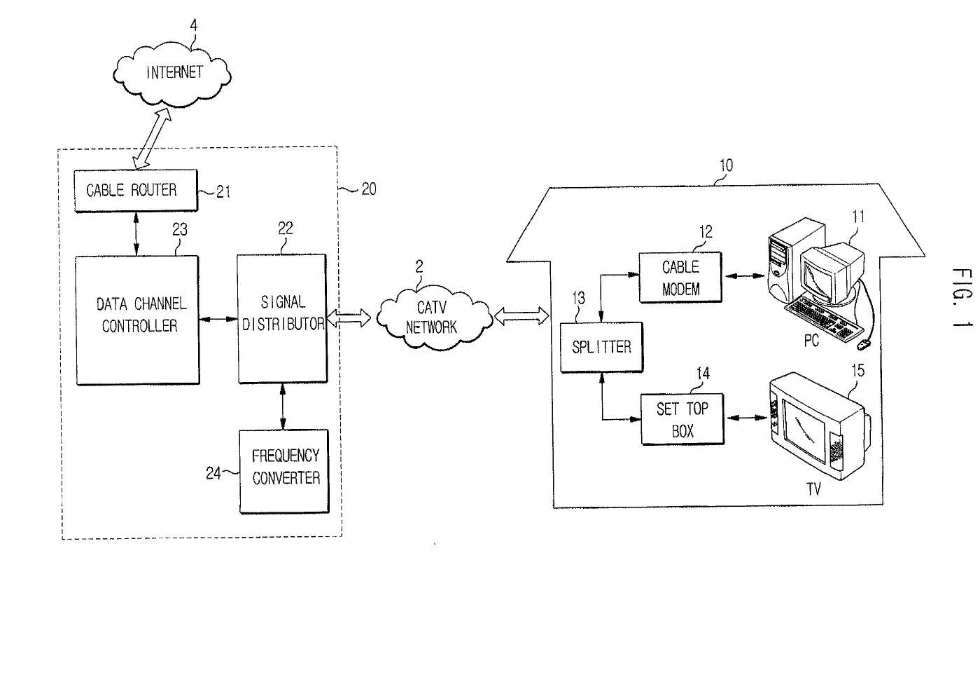

FIG. 2 is a schematic diagram of a conventional telecommunication system with downstream data transfer over a cable television channel and upstream data transfer by other media;

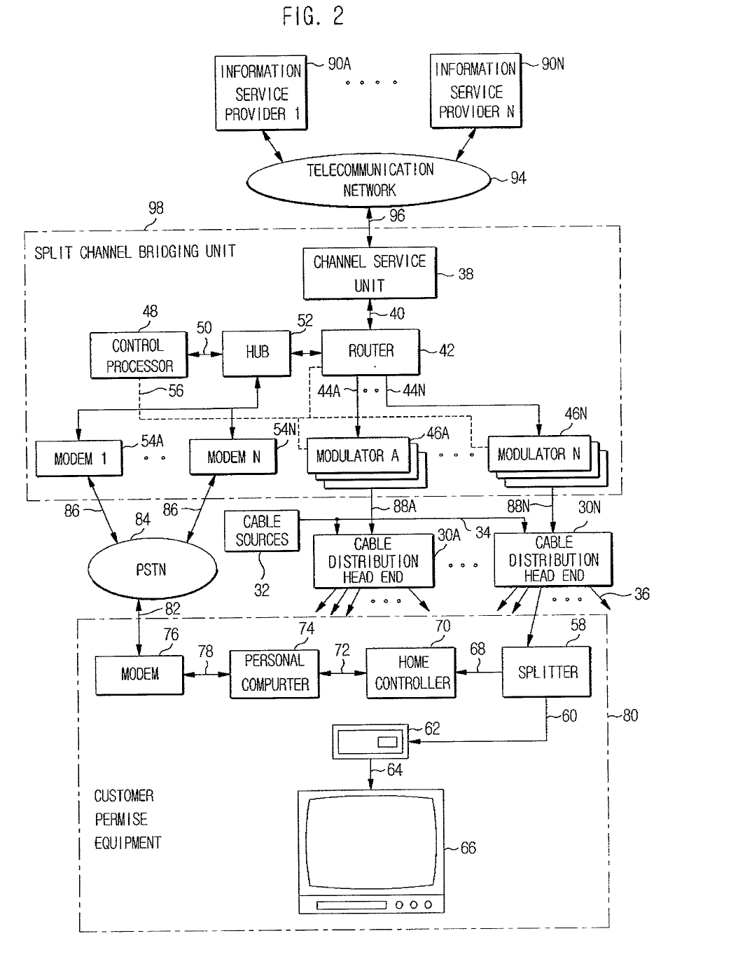

FIG. 3 is a schematic diagram of another conventional telecommunication system with downstream data transfer over a cable television channel and upstream data transfer by other media;

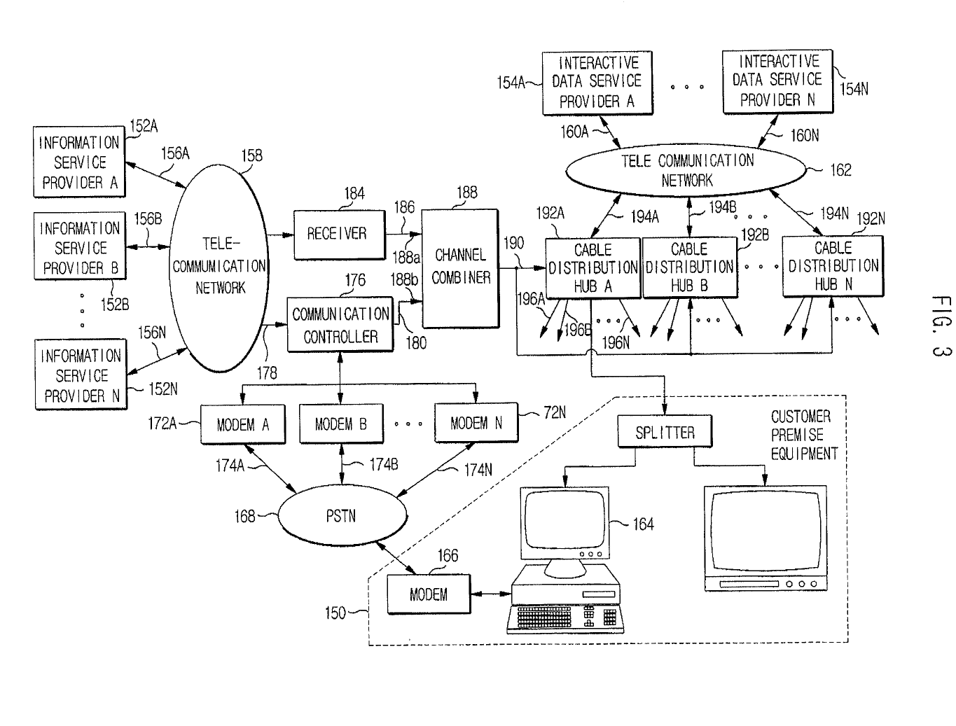

FIG. 4 is a block diagram of a communication system which uses a broadcasting distribution network as a downstream communication channel to provide requested information, and a PSTN network with an ARS system as an upstream communication channel in accordance with a preferred embodiment of the present invention;

FIG. 5 is a block diagram of the broadcasting control center of the communication system of FIG. 4;

FIG. 6 is a flow chart that illustrates a method of providing multimedia data based upon a user's request on an ARS system as an upstream communication path in accordance with a preferred embodiment of the present invention;

FIG. 7 is a format for requesting data via user's customer premise equipment through an ARS system as an upstream communication path in accordance with a preferred embodiment of the present invention;

FIG. 8 is a block diagram of a communication system which uses a broadcasting distribution network as a downstream communication channel to provide requested information, and uses the Internet as an upstream communication channel in accordance with a preferred embodiment of the present invention;

FIG. 9 is a block diagram of the broadcasting control center of the communication system of FIG. 8;

FIG. 10 is a flowchart that illustrates a method of receiving requests for music on the Internet from user's customer premise equipment on Internet as an upstream communication path in accordance with a preferred embodiment of the present invention;

FIG. 11 is a flowchart that illustrates a method of receiving requests on the Internet for moving pictures from user's customer premise equipment as an upstream communication path in accordance with a preferred embodiment of the present invention;

FIG. 12 is a flowchart that illustrates a method of transmitting broadcasts applying a signal based upon the user's request to a specified local broadcasting center in accordance with a preferred embodiment of the present invention;

FIG. 13 shows the data format of the broadcast applying signal transmitted from the broadcasting control center to the specified local broadcasting center in accordance with a preferred embodiment of the present invention;

FIG. 14 is a block diagram of the local broadcasting center in accordance with a preferred embodiment of the present invention;

FIG. 15 is a flowchart that illustrates a method of propagating broadcasting signals from the local broadcasting center to customer premise equipments of local user in accordance with a preferred embodiment of the present invention;

FIG. 16 is a diagram that illustrates the process of propagating requested multimedia data through the broadcasting distribution network with uni-channel services in accordance with a preferred embodiment of the present invention; and

FIG. 17 is a diagram that illustrates a process of propagating requested multimedia data through the broadcasting distribution network with multi-channel services in accordance with a preferred embodiment of the present invention.

Identically labeled elements appearing in different diagrams described above refer to the same elements but may not be referenced in the descriptions for all figures.

### DETAILED DESCRIPTION OF THE INVENTION

Hereinafter, the preferred embodiments of the present invention will be explained in more detail with reference to the accompanying drawings.

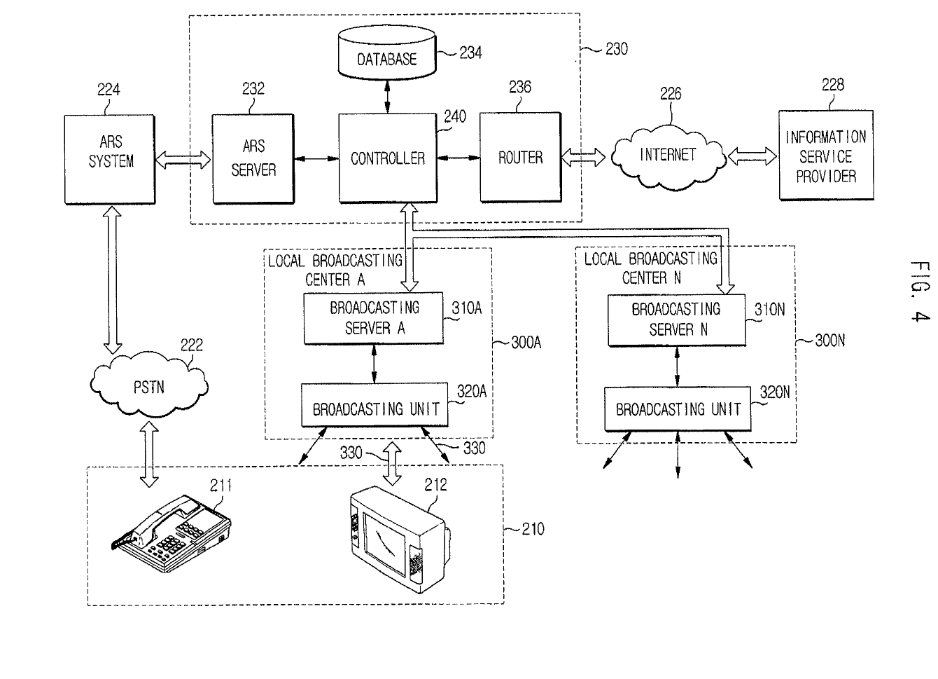

A schematic diagram illustrating communication system which uses local TV broadcasting channel as a downstream data transfer to provide multimedia data corresponding to a customer's request, and a telephone network with an automatic response service (ARS) system as an upstream data transfer for the present invention is shown in FIG. 4.

With reference to FIG. 4, the communication system includes customer premise equipment 210, a local broadcasting center 300A-300N for propagating a broadcasting signal simultaneously to the plurality of customer premise equipment 210 within limited area, and a broadcasting control center 230 for transmitting broadcast applying signal to a local broadcasting centers 300A-300N corresponding to a customer's request.

A customer premise equipment 210 requests for multimedia data to a broadcasting control center 230 through a wired or wireless telephone 211. For example, a dual tone multi frequency (DTMF) signal is generated by a telephone 211 according to the customer's input. The ARS system 224 receives the DTMF signal from the customer's telephone 211. If a connection between the ARS system 224 and the customer's telephone 211 is created, the customer inputs a specified code number into the telephone 211 corresponding to a guide provided by the ARS system 224. The DTMF signal comprises a plurality of different frequency signals corresponding to the respective numbers of customer's telephone 211. The DTMF signal consists of one high frequency signal and the other low frequency signal associated with each number of customer's telephone 211. For this reason, the DTMF signal is not generated by to the customer's tone of the voice.

The broadcasting control center 230 may include an ARS server 232 connected to the ARS system 224 for controlling comments that are provided to the customer through the PSTN 222. Also, the broadcasting control center 230 may get a supply of multimedia data such as audio data and video data from information service providers 228 or from contents providers through the Internet 226. In order to receive this supply of data, the broadcasting control center 230 needs a router 236 for connecting to the Internet 226. The multimedia data supported by Internet service providers 228 or by contents providers is edited in the broadcasting control center 230 so that it can be seen and heard by a customer via a TV 212 among customer premise equipment 210.

Generally, the multimedia audio and video data are compressed and stored for convenience in transmitting it. Compressed audio data typically requires a bandwidth of 13-64 Kilobits per second and compressed video data requires a bandwidth of 25-150 Kilobits per second, depending upon the compression method. Therefore, in the case that large volumes of multimedia data are transmitted, it is preferable that multimedia data is stored at local broadcasting centers 300A-300N near the customer premise equipment 210. Furthermore, the summary data, e.g., descriptions of data class, broadcasting time and multimedia data code, are preferably stored at a broadcasting control center 230, while multimedia data are stored at local broadcasting centers 300A-300N.

The controller 240 of the broadcasting control center 230 receives a request from the ARS server 232 and detects a data code, which indicates multimedia data corresponding to customer's request, an area code, which indicates the customer's residential area, and a broadcasting center code, which indicates a specific local broadcasting center coupled to the customer premise equipment. Then the controller 240 generates a broadcasting applying signal, which includes the detected codes in addition to a customer's request, to be sent to a specified local broadcasting center 300A-300N. The specified local broadcasting center 300A-300N transmits the multimedia data to customer premise equipment in the service area by means of a broadcasting unit 320A-320N corresponding to the broadcast applying signal received from the broadcasting control center.

Generally, subscribers using broadcasting service do not require multimedia data all the time, so that it is inefficient to assign channels for receiving multimedia data to each subscriber. Therefore, it is preferable that each local broadcasting center 300A-300N, which covers a limited local area, e.g., a district, a village or a city, provides customers in a limited service area with multimedia data corresponding to the customer's request over a TV channel 330.

In accordance with the present invention, local broadcasting centers 300A-300N also provide standby schedule data. Therefore, customers in the same service area for TV broadcasting can make inquiries multimedia data depending upon the remaining time of standby data and type of on-air data, e.g., music data, home shopping data, animation/movie data, or useful information.

The local broadcasting centers 300A-300N provide broadcasting services to a plurality of customer premise equipment 210 as the object of its service in a limited area. For example, customers who reside in an area where there is trouble with broadcasting signal detection, such as remote mountain villages, can construct a wired TV network in such areas and receive the broadcasting signal either on-air or standby form through a wired TV broadcasting channel. The local broadcasting centers 300A-300N may provide various multimedia data through a plurality of TV broadcasting channels. Or local broadcasting centers 300A-300N may provide various multimedia data through one TV broadcasting channel with different broadcasting times for each kind of multimedia data. Therefore, each local broadcasting center 300A-300N may include broadcasting units 320A-320N for propagating broadcasting signals to the corresponding customer premise equipment through a TV broadcasting channel 330.

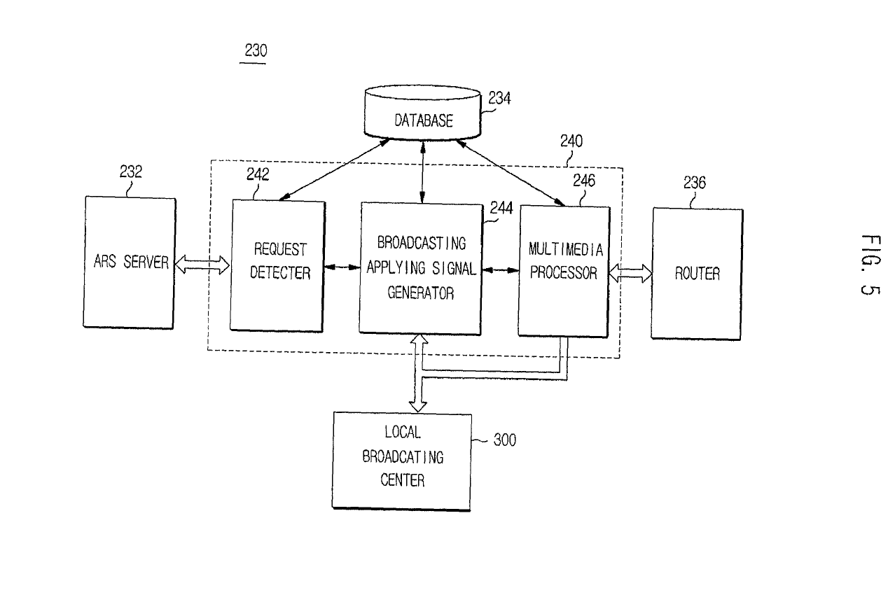

A block diagram of a broadcasting control center 230 in accordance with a preferred embodiment of the present invention is shown in FIG. 5.

With reference to FIG. 5, the broadcasting control center 230 may include an ARS server 232, a controller 240, a database 234 and a router 236. The ARS server 232 receives the customer's request through the ARS system 224.

The controller 240 may include a request detector 242, a broadcasting applying signal generator 244 and a multimedia processor 246.

The multimedia processor 246 converts the raw multimedia data supplied through the router 236 into specified data format. Then the multimedia processor 246 transmits the multimedia data with a specified data format to the local broadcasting centers 300A-300N. Also, the multimedia processor 246 stores the related summary data in a database 234. The raw multimedia data may be supplied through the Internet 226 or by readable storage media, e.g., a hard disk or CD-ROM, directly from the contents providers. The multimedia processor 246 generates summary data, e.g., the kind of data, their playing time and name, corresponding to the supplied multimedia data. And, the multimedia processor 246 stores them in a database 234. Also, the multimedia processor 246 provides the core data, which is for displaying on the customer's TV, to a broadcasting server 310A-310N in the local broadcasting center 300A-300N coupled to the customer premise equipment.

More particularly, the multimedia processor 246 classifies the multimedia data, for example, music data, home shopping data, animation/movie data or useful information, and gives codes to each kind of multimedia data. In the case that a uni-channel service is provided by the local broadcasting center, the multimedia processor 246 appoints the playing time of the each kind of multimedia data. On the other hand, in the case that multi-channel services are provided by the local broadcasting center, the multimedia processor 246 appoints the code to each channel which the multimedia data may be provided. Also, in using multi-channel services, the playing time may be added to the multimedia data. Therefore, summary data, e.g., the kind of multimedia data, the TV broadcasting channel, the playing time and the name of the data, are stored in a database 234 within the broadcasting control center 230.

The request detector 242 detects a customer's residential area, TV channel and selected multimedia data from the customer's request received through an ARS server 232. Then, the request detector 242 selects the specified area code, local broadcasting center code, TV channel code and multimedia data code from the database 234.

The broadcasting applying signal generator 244 creates an broadcasting applying signal, which includes the request date/time, a checksum bit added to the local area code, a local broadcasting center code, a TV channel code and a multimedia data code. The broadcasting applying signal is provided to the broadcasting servers 310A-310N within specified local broadcasting center 300A-300N. The customer can see and hear the requested multimedia data on a TV in accordance with the broadcasting signal from the local broadcasting center 300A-300N.

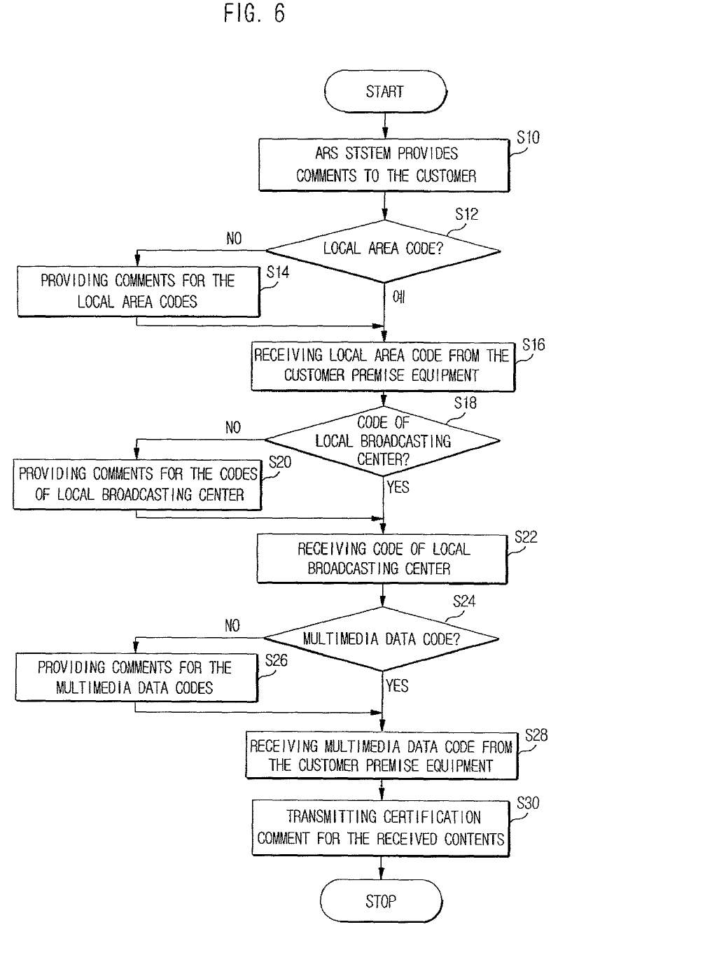

A flow chart that illustrates a method of requesting multimedia data from customer premise equipment through an ARS system as an upstream communication path in accordance with a preferred embodiment of the present invention is shown in FIG. 6.

With reference to FIG. 6, the ARS system 224 provides comments, which illustrate contents could be served to the customer premise equipment 210, if the customer premise equipment connects to the ARS system 224 using a telephone 211 (step s10). The customer may know in advance the local area code, local broadcasting center code, TV channel code and multimedia data code which indicates for example, music data, home shopping data, animation/movie data and useful information. In this case, the customer can input a specific local area code, local broadcasting center code, TV channel code and multimedia data code on the telephone 211 sequentially (step s16). If not, the user can input specific codes sequentially according to the service comments provided by the ARS system (step s14).

There may be just one local broadcasting center or plurality of local broadcasting centers in one limited local area. If there is plurality of local broadcasting centers, the ARS system 224 can provide the comments for the local broadcasting center's codes (step s20). Also, the customer can directly input a specific code of local broadcasting center by using buttons on a telephone if the customer knows that code in advance (step s22). Similarly, an ARS system 224 can provide comments of serviceable multimedia data codes (step s26), or the customer can directly input multimedia data codes using a telephone (step s28).

A local broadcasting center may use one TV broadcasting channel for providing selected multimedia data based on time division, and another local broadcasting center may use plurality of TV broadcasting channels corresponding to each kind of multimedia data. In the case that a local broadcasting center has multi-channel services, the step of selecting a specified local broadcasting center is also necessary.

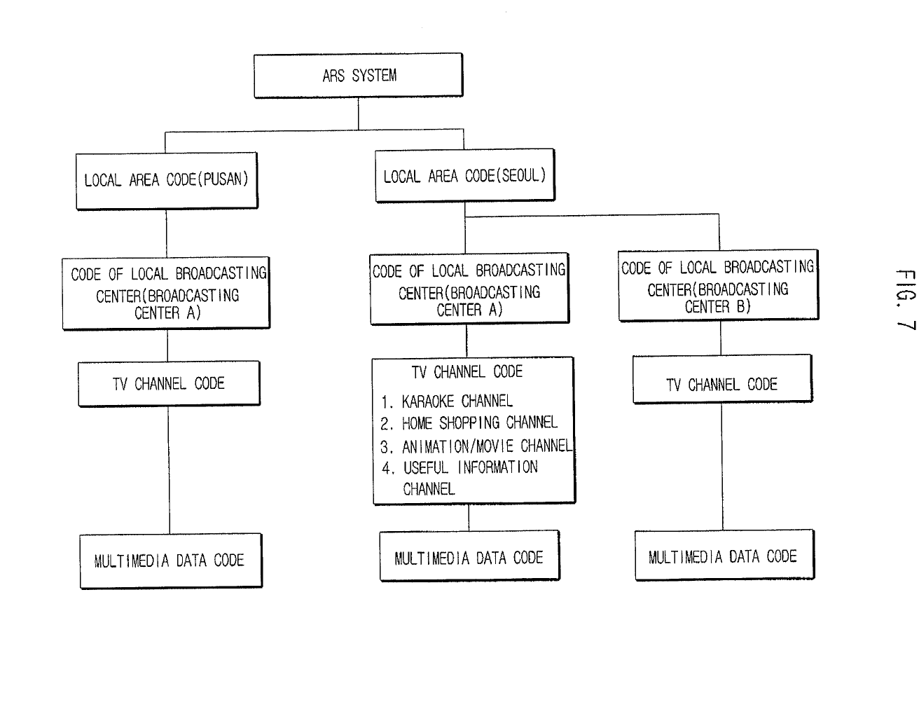

A data format of request from customer premise equipment through ARS system as an upstream data transfer in accordance with a preferred embodiment of the present invention is shown in FIG. 7.

With reference to the FIG. 7, the ARS system may have at least one of local area code according to the service area, e.g., Seoul, Pusan and Taegu, respectively. At least one of local broadcasting center codes is located at the lower level of the local area code. If there is one local broadcasting center, just one local broadcasting center code is assigned, and otherwise plurality of the local broadcasting center codes are assigned to them, respectively.

The local broadcasting center may have at least one of TV broadcasting channels for providing multimedia data. In the case that the local broadcasting center has one channel and serves various multimedia data in accordance with different period of the playing time, just one TV channel code is located under the local broadcasting center code and multimedia data code is located under the TV channel code. On the other hand, in the case that the local broadcasting center has plurality of channels according to the different kind of the multimedia data, plurality of the multimedia data code are located under the each TV channel code, respectively.

If the customer inputs the local area code, local broadcasting center code, TV channel code and multimedia data code, the ARS system provides certification comment for the input contents (step s30).

On the other hand, the customer can request the multimedia data through Internet.

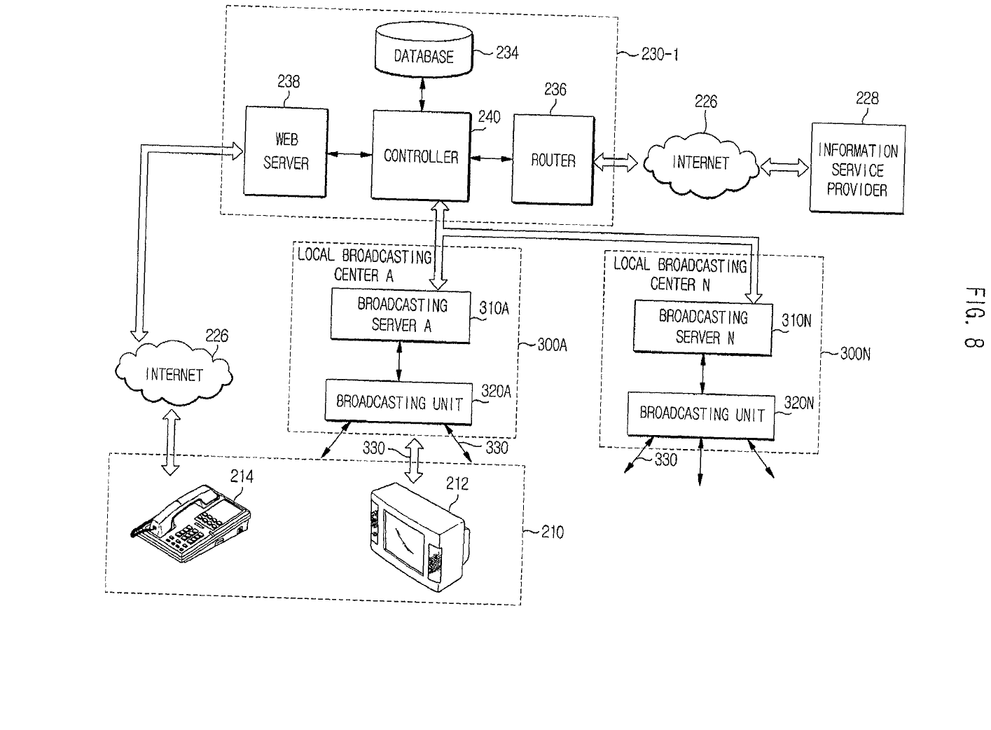

A block diagram of a communication system which uses local TV broadcasting channel as a downstream data transfer to provide requested multimedia data and Internet as a upstream data transfer in accordance with a preferred embodiment of the present invention is shown in FIG. 8.

With reference to FIG. 8, the communication system of the present invention consists of Internet 226 as a upstream data transfer. This is indicates that the broadcasting control center 230-1 includes a web server 238 instead of the ARS server. Therefore, the communication system uses Internet 226 as a upstream data transfer instead of the telephone network, e.g., PSTN and web server 238 instead of the ARS server. And other configuration and process are the same with that of FIG. 4.

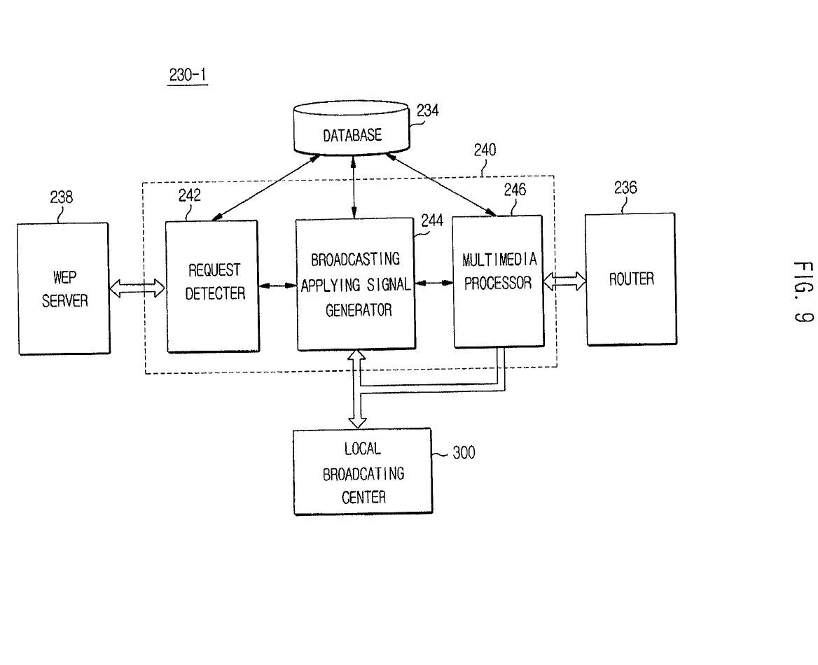

A block diagram of a broadcasting control center 230-1 of the communication system of FIG. 8 is shown in FIG. 9.

With reference to FIG. 9, the broadcasting control center 230-1 may include a web server 238, a controller 240, a database 234 and a router 236. The web server 238 receives the customer's request through the Internet 226.

The controller 240 may include a request detector 242, broadcasting applying signal generator 244 and a multimedia processor 246.

The multimedia processor 246 converts the raw multimedia data supplied through the router 236 to the specified data format. And then the multimedia processor 246 transmits the converted multimedia data with specified data format to the local broadcasting centers 300A-300N. And, the multimedia processor 246 stores the summary data of them in the database 234.

The request detector 242 detects local area, TV channel and selected multimedia data corresponding to the customer's request received through the web server 238. Then, the request detector 242 selects the local area code, local broadcasting center code, TV channel code and multimedia data code from the database 234.

The broadcasting applying signal generator 244 creates the broadcasting applying signal, which includes request date/time and checksum bit added to the local area code, local broadcasting center code, TV channel code and multimedia data code. The broadcasting applying signal is provided to the broadcasting server 310A-310N within the specified local broadcasting center 300A-300N.

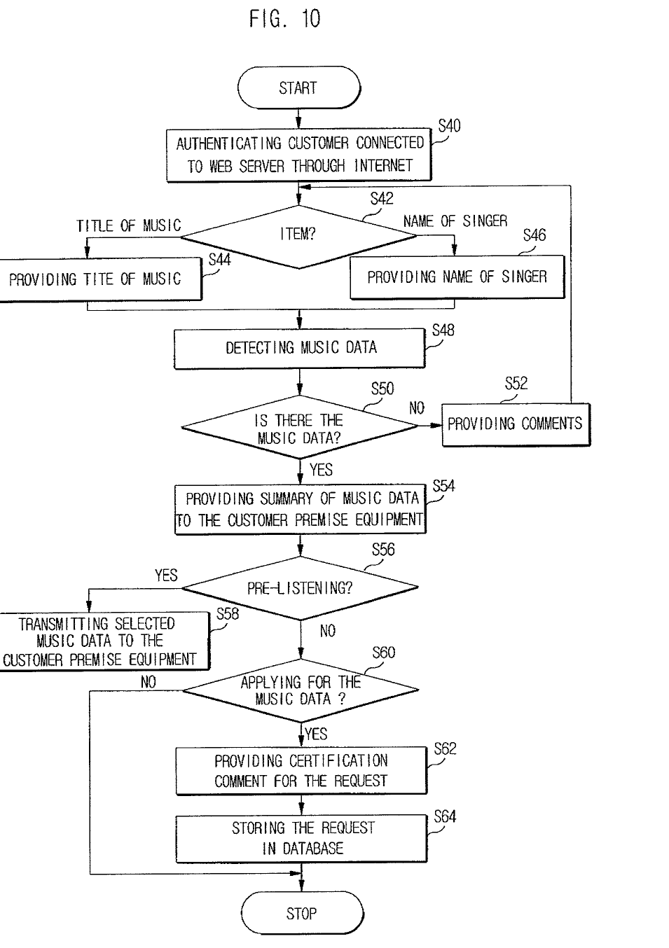

A flowchart that illustrates a method of receiving request of music from customer premise equipment on Internet as an upstream data transfer in accordance with a preferred embodiment of the present invention is shown in FIG. 10.

With reference to FIG. 10, the customer requests the connection with the web server 238 using the computer system 214 in the customer premise equipment 210 through the Internet 226. Then, the web server 238 has the authenticating process for the customer (step s40) using private information of the connected customer, for example, ID and password.

The broadcasting control center 230-1 provides serviceable music data to the authenticated customer. In this time, the customer can search desired music data using title of music or name of singer. If the customer selects the title of music for searching the music data (step s42), the broadcasting control center 230-1 provides the list of the music in order of the title (step s44). And, if the customer selects the name of singer for searching the music data (step s42), the broadcasting control center 230-1 provides the list of the music in order of the name of the singer (step s46). On the other hand, the customer can search desired music data directly by inputting the title of music in the searching windows.

The broadcasting control center 230-1 detects the desired music data from the database in accordance with customer's input (step s48). If the requested music data are in the database, the broadcasting control center 230-1 provides the summary data of the music, e.g., music code, name of singer and playing time, to the customer (step s54). If there is not desired music data in the database, the comments for indicating ‘no data’ are provided to the customer (step s52).

In this time, the computer system of the customer premise equipment is being connected to the web server hence it is easy to listening the requested music previously. As it were, if the customer requests the pre-listening the desired music (step s56), the broadcasting control center 230-1 transmits the music data to the customer premise equipment (step s58). Therefore, it is preferable that the music data, which could have MP3 format capable of playing on the web, are stores in the database of the broadcasting control center 230-1, because the customer can listen the music through the Internet.

Then, if the customer applies for the music data to broadcasting to the customer premise equipment in the limited local area (step s60), the broadcasting control center 230-1 provides the certification comment (step s62). And, the broadcasting control center 230-1 stores the contents of customer's applying for (step s64). Therefore, the customer can hear the desired music on the TV within the customer premise equipment. And the customer can use karaoke service by the sound of music.

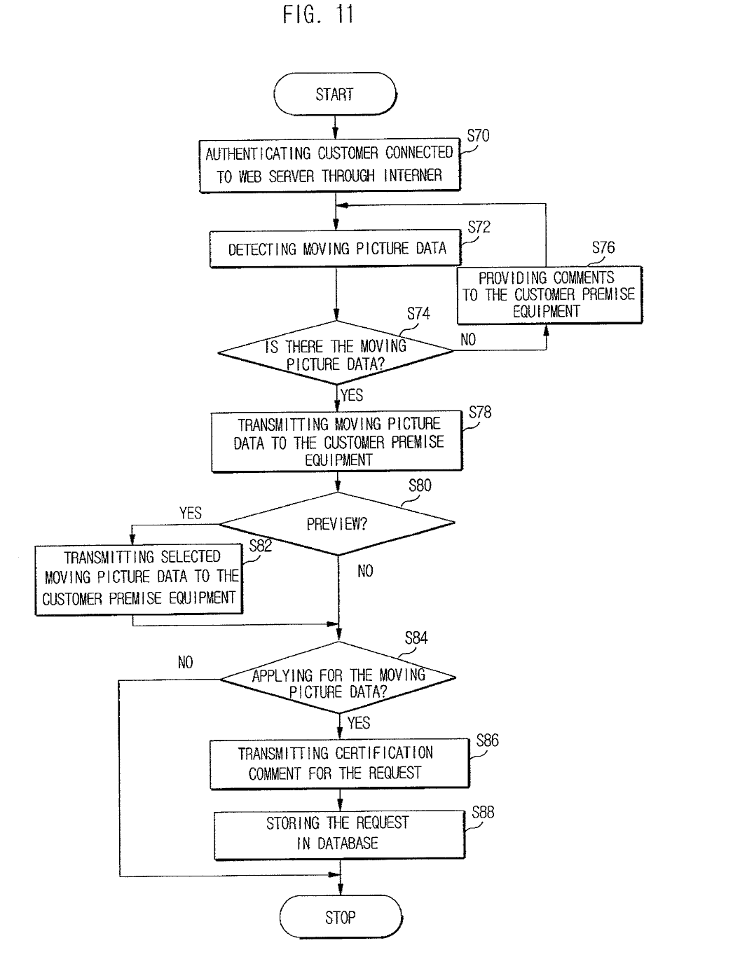

A flowchart that illustrates a method of receiving customer's request for the moving picture from customer premise equipment on Internet as an upstream data transfer in accordance with a preferred embodiment of the present invention is shown in FIG. 11.

With reference to the FIG. 11, the customer requests the connection to the web server 238 within the broadcasting control center 230-1 through Internet 226. The web server 238 has the process for authenticating the customer using private information for the customer, e.g., ID, password, customer's name and resident registration number (step s70).

The broadcasting control center 230-1 detects desired moving picture data from the database according to the customer's request (step s72). If there is requested moving picture data in the database (step s74), the broadcasting control center 230-1 transmits summary of the moving picture data, e.g., data code, title or playing time (step s78). If not, the broadcasting control center 230-1 provides ‘no data’ comments and demands request again to the customer (step s76).

In this time, the computer system of the customer premise equipment 210 is being connected to the web server. Hence it is easy to preview the requested moving picture, it is preferable to store the moving picture data in the database of the broadcasting control center 230-1. As it were, if the customer requests the preview of the desired moving picture (step s80), the broadcasting control center 230-1 transmits the moving picture data to the customer premise equipment (step s82). Therefore, it is preferable that the moving picture data, which could have a format such as rm, ra, or mpeg capable of playing, for example, by the real player or windows media player, are stores in the database within the broadcasting control center 230-1. In the case of using Internet as upstream data transfer, preferably moving picture data are classified to the web-based data and TV channel-based data, the former stores in the broadcasting control center 230-1, and the latter stores in the local broadcasting center.

Then, if the customer applies for the moving picture data for the broadcasting (step s84), the broadcasting control center 230-1 provides the certification comment (step s86). And, the broadcasting control center 230-1 stores the contents of customer's applying for (step s88). Therefore, the user can see and hear the requested moving picture such as animation and movie from the TV in the customer premise equipment.

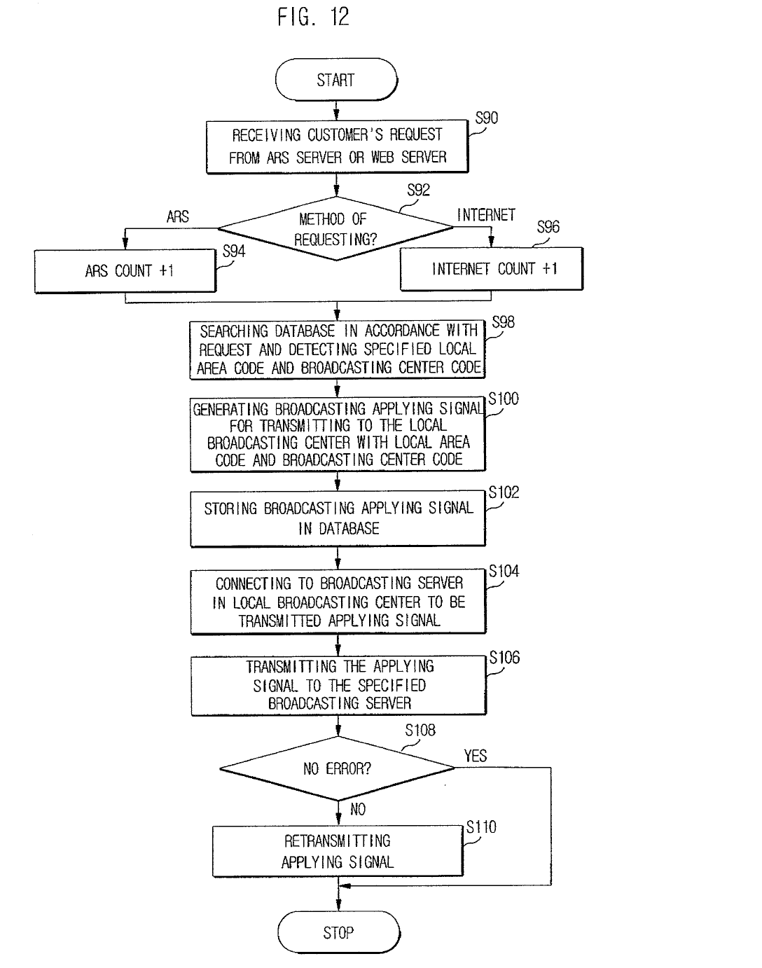

A flowchart that illustrates a method of transmitting broadcasting applying signal based upon the customer's request to the local broadcasting center in accordance with a preferred embodiment of the present invention is shown in FIG. 12.

With reference to FIG. 12, the broadcasting control center receives the request for the multimedia data through the ARS server or web server (step s90). The request for the multimedia data is transmitted to the broadcasting control center by the telephone or computer system within the customer premise equipment. In accordance with the customer's request through ARS server or web server, ARS count or Internet count is increased (step s94). The result of the count may be used to take statistics.

If the local area code, local broadcasting center code, TV channel code and multimedia data code are provided by customer, the controller of the broadcasting control center detects information used to generate broadcasting applying signal from the database (step s98). The broadcasting applying signal is for applying the local broadcasting center for propagating desired multimedia data according to the customer's request to the customer premise equipment. Therefore, the broadcasting applying signal may include additional data, e.g., transmitting date, transmitting time, and request time, added to the local area code, local broadcasting center code, TV channel code and multimedia data code.

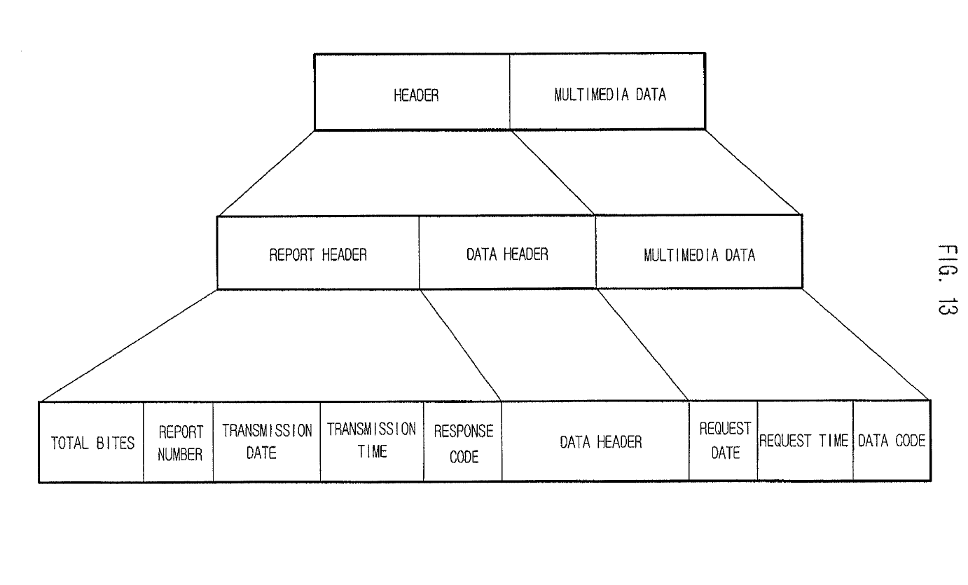

A data format of broadcasting applying signal transmitted from the broadcasting control center to the local broadcasting center according to the customer's request in accordance with a preferred embodiment of the present invention is shown in FIG. 13.

With reference to the FIG. 13, the broadcasting applying signal may have multimedia data element, which illustrates desired multimedia data for propagating from local broadcasting center to plurality of the customer premise equipment, and header element for controlling the transmission of the broadcast applying signal.

The multimedia data element may consist of the multimedia data code, request date and request time. The multimedia data code can illustrate music data, home shopping data, animation/movie data or useful information data according to the customer's request.

The header element may include data header and report header, said data header illustrates the number of customer's request for the multimedia data. The report header may include report number, transmitting date, transmitting time and response code, said report number illustrates the kind of multimedia data, i.e. master data or optional data, Furthermore, the report header may include total bites, which illustrates total length of the broadcasting applying signal for judging the arrival of the broadcasting applying signal to the local broadcasting center. IP address or port number of the broadcasting server within the local broadcasting center may be used to transmit the broadcasting applying signal.

In this way, the broadcasting applying signal may be stored in the database of the broadcasting control center for making statistics of the transmission error and details of the customer's request (step s102). The broadcasting applying signal may be arranged in the broadcasting control center according to the plurality of the customer's request. Then, the broadcasting control center is connected to the local broadcasting center according to the customer's request (step s104) and transmits the broadcasting applying signal to that (step s106).

In the process of transmitting broadcasting applying signal, the broadcasting control center judges the things whether the broadcasting applying signal is transmitted normally or not, according to the response code from the local broadcasting center. If the broadcasting control center receives back normal response, i.e. acknowledge signal, from the local broadcasting center, the broadcasting control center determines no error in the transmission process of the broadcasting applying signal (step s108). If the response is not provided from the local broadcasting center, which indicates transmission error, the broadcasting control center retransmits the broadcasting applying signal (step s110).

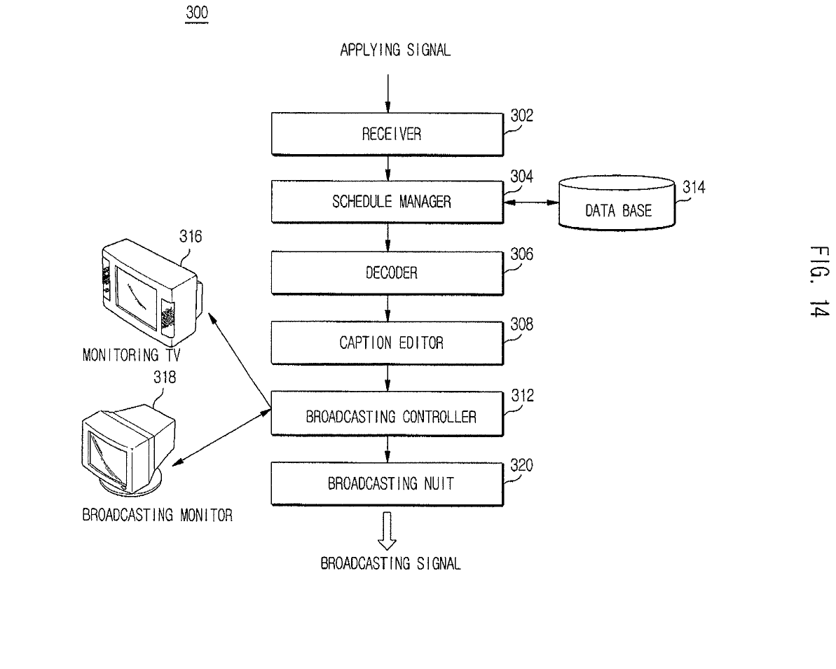

A block diagram of the local broadcasting center in accordance with a preferred embodiment of the present invention is shown in FIG. 14.

With reference to FIG. 14, local broadcasting centers 300A-300N may have functions that detects desired multimedia data according to the broadcasting applying signal from the broadcasting control center, converts detected multimedia data, which stores in the digital form, to analog multimedia data, edits the analog multimedia data to make view on TV, and propagates the edited multimedia data to the customer premise equipment through the TV broadcasting channel according to the customer's request.

The database 314 is for storing multimedia data for transmitting through the TV broadcasting channel. The multimedia data may be large-volume video data, audio data, animation data or text data. Preferably, the multimedia data are stored in the digital form of MPEG 2 (Moving Picture Expert Group) for efficient transmission and storage. Furthermore, it is preferable to prevent the size of the multimedia data, which are transmitted through TV broadcasting channel, from exceeding 4 Gigabytes, which is data size for playing on TV for 1 hour.

The receiver 302 receives the broadcasting applying signal from the broadcasting control center. The schedule manager 304 detects desired multimedia data from the database 314 according to the broadcasting applying signal and controls the propagation of the detected multimedia data in accordance with request date and request time. The digital multimedia data, e.g., music data, home shopping data, animation/movie data and useful information, stored in the database 314 are converted to the analog form for propagating through TV broadcasting channel. Therefore, local broadcasting center may have decoder 306, i.e. DA converter, to convert digital multimedia data to analog multimedia data. In this way, the multimedia data may be separated to audio data and video data, each audio data and video data may be converted to analog audio data and analog video data due to audio decoder and video decoder, respectively.

The caption editor 308 edits screen contents to be displayed on the TV by supplying various additive data to the converted analog multimedia data. As it were, if the additive data, e.g., ARS number or uniform resource locator (URL), local area code, local broadcasting center code, multimedia data code, TV channel code, standby data and remaining time, are supplied on the TV screen, the customers are apt to request desired multimedia data. Therefore, customers can request various multimedia data by ARS system or web server.

Also, customers can estimate start time of the desired multimedia data due to confirm standby data and remaining time, and therefore the customers can manage time efficiently.

The broadcasting controller 312 controls the propagation of the broadcasting signal, which is edited in the caption editor 308, from the broadcasting unit 320 to the customer premise equipment 210 subscribed to the local broadcasting center 300A-300N. The broadcasting controller 312 provides broadcasting signal to the monitoring TV 316 and broadcasting monitor 318 in the local broadcasting center 300 for manager's confirmation. The manager can see broadcasting condition for example, quality of screen and quality of sound in the customer premise equipment, using the monitoring TV 316. And therefore, the manager can control the transmission of the broadcasting signal using broadcasting monitor 318.

Furthermore, the broadcasting monitor 318 may have alarm device, e.g., Light Emitting Diode (LED), for displaying error message according to the error of the audio signal or video signal. Therefore, the manager can confirm occurrence of error, so that the manager can correct error conveniently. Also, in the case of using multi-channel for propagating broadcasting signal from the local broadcasting center to the customer premise equipments, the manager can confirm propagating condition in each channel using the broadcasting monitor 318 and monitoring TV 316.

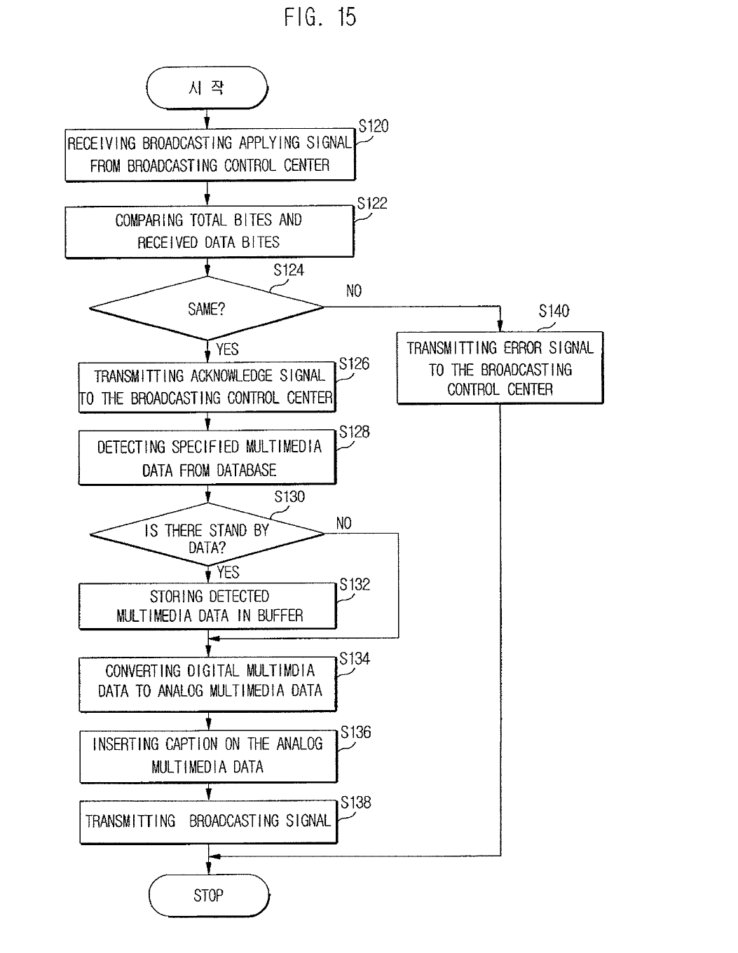

A flowchart that illustrates a method of propagating broadcasting signal from the local broadcasting center to the customer premise equipments in accordance with a preferred embodiment of the present invention is shown in FIG. 15.

With reference to the FIG. 15, the local broadcasting centers 300A-300N receive the broadcasting applying signal from the broadcasting control center (step s120) and detect whether error occurs in the broadcasting applying signal or not. For this process, the local broadcasting centers 300A-300N compare total bites in the report header of FIG. 13 with total length of the received broadcasting applying signal (step s122). If the result is same, i.e. ‘no error’ (step s124), normal received response (acknowledge) is transmitted back to the broadcasting control center (step s126), and if not, the local broadcasting center requests retransmission of the broadcasting applying signal to the broadcasting control center due to error response (step s140).

If the local broadcasting center receives the broadcasting applying signal normally, the specified multimedia data are detected from database according to the broadcasting applying signal (step s128). In the case of existing multimedia data standby data or on-air data (step s130), the detected multimedia data are stores in buffer (step s132). Otherwise, the detected multimedia data are propagated to the customer premise equipment without buffering.

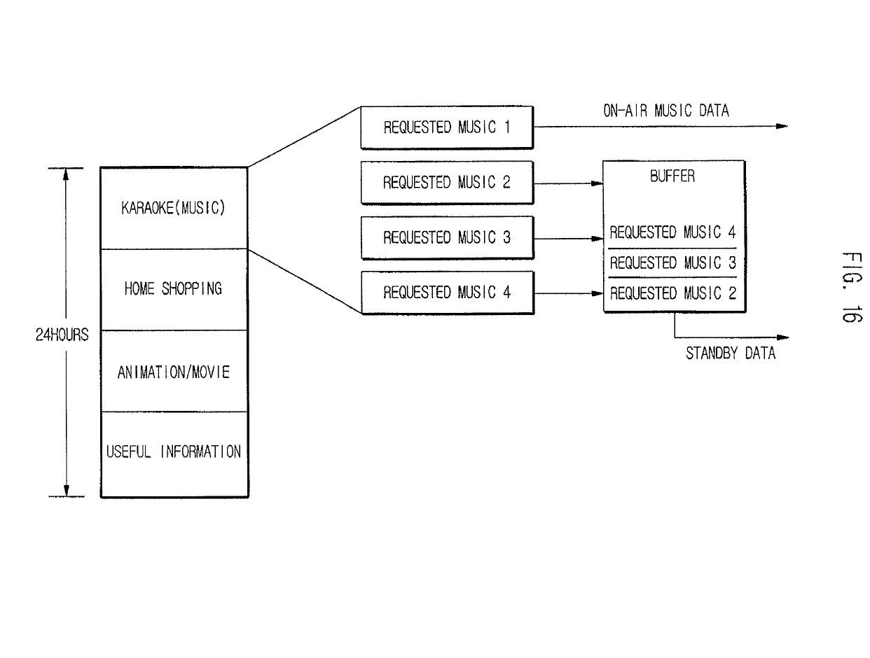

A diagram that explains a process of propagating desired multimedia data through the local TV broadcasting uni-channel in accordance with preferred embodiment of a present invention is shown in FIG. 16.

With reference the FIG. 16, for propagating multimedia data, e.g., music data, home shopping data, animation/movie data and useful information, with uni-channel, there is need to divide 24 hours of a day into plurality of the broadcasting time with definite interval. Therefore, each kind of multimedia data is provided in each definite interval.

For example, if there are requests of music from customer premise equipment during the time of providing karaoke service, the requested music data are stored in buffer in order of request. If the requested music data are four, i.e. from requested music 1 to requested music data 4, the requested music data 1 is propagated to the customer premise equipment, and others are stored in buffer. After the propagation of the requested music data 1 is finished, next requested music data 2 is propagated to the customer premise equipment. The buffer may provide the requested music data in order of First In First Out (FIFO).

On the other hand, it is possible to propagate multimedia data using multi-channel for transmitting each kind of them.

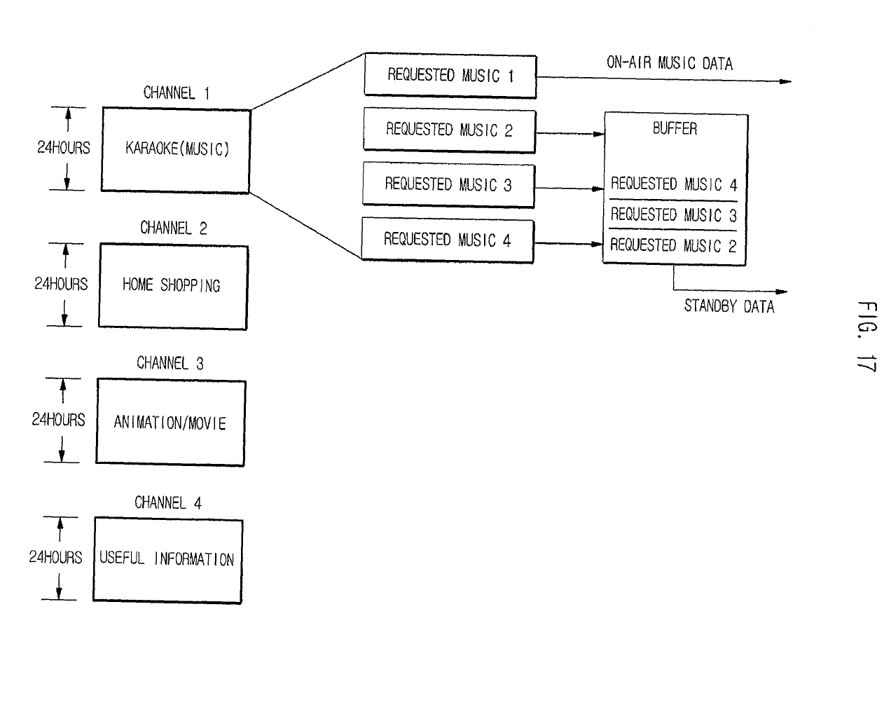

A diagram that explains a process of propagating requested multimedia data through the local TV broadcasting multi-channel in accordance with preferred embodiment of a present invention is shown in FIG. 17.

FIG, 17 shows the occasion that karaoke service corresponds to channel 1, home shopping service corresponds to channel 2, animation/movie service corresponds to channel 3 and useful information service corresponds to channel 4. Therefore, each kind of multimedia data can be provided on each channel.

In the karaoke service, the customers can request music in channel 1. The requested music data, for example, from the requested music data 1 to the requested music data 4, are stored sequentially in buffer. The requested music are propagated to the customer premise equipment in order of request. Similarly, in channel 2, channel 3 and channel 4, each multimedia data are stored in buffer sequentially and propagated to the customer premise equipment according to the requested order.

The customers can estimate easily the propagation order by caption of screen, e.g., the order of standby multimedia data and playing time of each data.

The digital multimedia data are converted to analog multimedia data for propagating through local TV broadcasting channel (step s134). Then, the caption data, for example, code of requesting multimedia data by ARS system or Internet, and summary of multimedia data capable of broadcasting, are added to the analog multimedia data (step s136). This helps customers to manage the time for using service by confirmation of remaining time. The broadcasting signal i.e. multimedia data included caption, is propagated the customer premise equipments through local TV broadcasting channel (step s138).

As described above, in the communication method and system of the present invention, the customers can request multimedia data by computer system or telephone, and the customers can see and hear desired multimedia data on the TV without any device, for example, cable modem and splitter.

Also, the communication system of the present invention can increase data transmission rate and can enhance the efficiency of the data transmission by propagation of the broadcasting signal to the customer premise equipments in the range of limited area simultaneously. Therefore, it is possible to decrease the useless time for broadcasting and increase the effectiveness of using the local TV broadcasting channels.

Also, in the communication system of the present invention, because the core data of multimedia data are stored in the local broadcasting center, it is possible to propagate broadcasting signal faster.

While the present invention has been particularly shown and described with reference to preferred embodiments thereof, it will be appreciated that many variations, modifications and other applications of the present invention may be made.

What is claimed is:

1. A communication system for propagating multimedia data through a local television (TV) broadcasting channel as downstream data transfer to a plurality of customer premise equipment, and for receiving at least one customer's request through a telephone network as upstream data transfer, said communication system comprising:
a broadcasting control center for receiving at least one customer's request from at least one customer premise, and for transmitting broadcasting applying signal to a local broadcasting center corresponding to a customer's request; and
at least one local broadcasting center coupled to said broadcasting control center and the plurality of customer premise equipment, for propagating multimedia data corresponding to the customer's request through local TV broadcasting channels to the plurality of customer premise equipment corresponding to the broadcasting applying signal received from said broadcasting control center.

2. The communication system as in claim 1, wherein the telephone network is coupled to automatic response service (ARS) system.

3. The communication system as in claim 1, wherein said broadcasting control center comprises:
a database for storing at least one selected from the group consisting of customer's information, a summary of multimedia data, and summary related to said local broadcasting centers;
an automatic response service (ARS) server for receiving at least one customer's request from the at least one customer premise equipment, and providing service comments to at least one customer premise equipment through the telephone network; and
a controller for providing a broadcasting applying signal to said at least one local broadcasting center coupled to the at least one customer premise equipment according to the customer's request, the broadcasting applying signal comprises at least one selected from the group consisting of customer's information, a summary of the multimedia data, and summary related to said local broadcasting center.

4. The communication system as in claim 3, wherein the summary of the local broadcasting center comprises at least one selected from the group consisting of a local broadcasting center code, a local area code, and a local TV broadcasting channel code.

5. The communication system as in claim 3, wherein the summary of the multimedia data comprises multimedia data code, which is used for representing multimedia data.

6. The communication system as in claim 3, wherein said controller comprises:
a router for receiving multimedia data from at least one information service provider (ISP) through the Internet; and
a multimedia processor for generating at least one multimedia data code, storing the multimedia data code, and providing the multimedia data to said at least one local broadcasting center.

7. The communication system as in claim 1, wherein the broadcasting applying signal comprises at least one selected from the group consisting of a transmission code, a response code, a request code, a multimedia data code, and a checksum code, wherein the transmission code comprises a transmission date and a transmission time, the response code is used for certifying arrival of the broadcasting applying signal, the request code comprises a request data and a request time, and the checksum code is used for representing error of transmission.

8. The communication system as in claim 1, wherein said at least one local broadcasting center comprises:
a database for storing multimedia data, which are used for propagating through a local TV broadcasting channel;
a receiver for receiving the broadcasting applying signal from said broadcasting control center;
a schedule manager for detecting multimedia data from the database corresponding to the broadcasting applying signal, and for controlling the propagation time of the detected multimedia data;
a converter for converting the detected digital multimedia data into analog multimedia data;
a caption editor for generating analog broadcasting signal added caption data, wherein the caption data are displayed on TV within the customer premise equipment; and
a broadcasting controller for controlling the propagation of the analog broadcasting signal to plurality of customer premise equipment limited service area through the local TV broadcasting channel.

9. The communication system as in claim 8, wherein said schedule manager comprises a buffer for storing the analog broadcasting signal temporarily in order to propagate it through the local TV broadcasting channel in order of customers' requests.

10. The communication system as in claim 8, wherein the caption data comprises at least one selected from the group consisting of an automatic response service (ARS) phone number, a local area code, a local broadcasting center code, a TV channel code, a serviceable multimedia data code, a standby multimedia data code and a playing time of the standby multimedia data.

11. The communication system as in claim 8, wherein said local broadcasting center further comprises at least one broadcasting monitor in order to check screen condition and transmission condition of the multimedia data.

12. A method for propagating multimedia data through local television (TV) broadcasting channel as downstream data transfer to at least one customer premise equipment, and for receiving customer's request through a telephone network as upstream data transfer from at least one the customer premise equipment, the method comprising the steps of:
storing multimedia data in a database of at least one local broadcasting center,
storing a summary of multimedia data in a database of the broadcasting control center, wherein the summary of multimedia data are used for representing each multimedia data in local broadcasting centers;
receiving at least one customer's request from at least one customer premise equipment through the telephone network as upstream data transfer;
generating a broadcasting applying signal according to the at least one customer's request, wherein the broadcasting applying signal comprises at least one selected from the group consisting of customers' information, a summary of multimedia data, and a summary related to local broadcasting center;
transmitting the broadcasting applying signal to the local broadcasting center coupled to the customer premise equipment according to the customer's request;
detecting desired multimedia data from the local broadcasting center's database according to the broadcasting applying signal;
converting the detected digital multimedia data to analog broadcasting signal; and
propagating the analog broadcasting signal to plurality of customer premise equipment limited service area through the local TV broadcasting channel.

13. The method for propagating multimedia data as in claim 12, wherein the summary of local broadcasting center comprises at least one selected from the group consisting of a local broadcasting center code, a local area code, and a TV channel code.

14. The method for propagating multimedia data as in claim 12, wherein the summary of multimedia data is a code for representing multimedia data.

15. The method for propagating multimedia data as in claim 12, wherein the broadcasting applying signal comprises at least one selected from the group consisting of a transmission code, a response code, a request code, a multimedia data code, and a checksum code, wherein the transmission code comprises a transmission date and a transmission time, the response code is used for certifying arrival of the broadcasting applying signal, the request code comprises a request data and a request time, the checksum code is used for checking error of transmission.

16. The method for propagating multimedia data as in claim 12, wherein said step of converting detected digital multimedia data to analog broadcasting signal comprises the step of:
adding caption data to the analog broadcasting signal, wherein the caption data are displayed on TV within the customer premise equipment.

17. The method for propagating multimedia data as in claim 16, wherein the caption data comprises at least one selected from the group consisting of an automatic response service (ARS) phone number, a local area code, a local broadcasting center code, a TV channel code, a serviceable multimedia data code, a standby multimedia data code, and a playing time of the standby multimedia data.

18. A communication system for providing broadcasting applying signal to a local broadcasting center according to a customer's request, and for receiving the customer's request through a telephone network as upstream data transfer from at least one customer premise equipment, wherein the broadcasting applying signal is used for applying propagation of a multimedia data through a local television (TV) broadcasting channel as downstream data transfer to plurality of customer premise equipment, said communication system comprising:
a database for storing at least one selected from the group consisting of the customers' information, a summary of multimedia data, and a summary related to at least one local broadcasting center;
an automatic response service (ARS) server for receiving the customer's request, and providing service comments to the customer premise equipment through the telephone network;
a generator for generating the broadcasting applying signal, wherein the broadcasting applying signal comprises at least one selected from the group consisting of customer's information, a summary of the multimedia data, and a summary related the local broadcasting center; and
a transmitter for transmitting the broadcasting applying signal to the local broadcasting center coupled to the customer premise equipment according to the customer's request.

19. A method for transmitting broadcasting applying signal to a local broadcasting center, the broadcasting applying signal is used for applying propagation of multimedia data through a local television (TV) broadcasting channel as downstream data transfer to plurality of customer premise equipment, and for receiving customer's request through a telephone network as upstream data transfer from at least one customer premise equipment, the method comprising the steps of:
storing a summary of multimedia data and a summary related to at least one local broadcasting center, wherein the multimedia data are stored in the at least one local broadcasting center;
receiving at least one customer's request from at least one customer premise equipment through the telephone network as upstream data transfer;
generating a broadcasting applying signal, which is comprised of at least one selected from the group consisting of customer's information, a summary of the multimedia data, and a summary related to the local broadcasting center; and
transmitting the broadcasting applying signal to the local broadcasting center coupled to the customer premise equipment according to the customer's request.

20. A communication system for propagating multimedia data through a local television (TV) broadcasting channel as downstream data transfer to plurality of customer premise equipment according to at least one customer's request, and receiving a broadcasting applying signal from a broadcasting control center according to the customer's request, wherein the customer's request is provided through a communication channel as upstream data transfer from at least one customer premise equipment, said communication system comprising:
a database for storing multimedia data, wherein the multimedia data are propagated through the local TV broadcasting channel;
a receiver for receiving the broadcasting applying signal from the broadcasting control center, wherein the broadcast applying signal comprises at least one selected from the group consisting of at least customer's information, a summary of the multimedia data, and a summary related to the local broadcasting center;
a schedule manager for detecting the requested multimedia data from said database according to the broadcasting applying signal, and for controlling the propagation time of the detected multimedia data;
a converter for converting the detected digital multimedia data to analog multimedia data;
a caption editor for generating analog broadcasting signal added caption data, wherein the caption data are displayed on TV within customer premise equipment; and
a broadcasting controller for controlling the propagation of the analog broadcasting signal to a plurality of customer premise equipment limited service area through the local TV broadcasting channel.

21. A method for propagating multimedia data through local television (TV) broadcasting channel as downstream data transfer to a plurality of customer premise equipment according to a customer's request, and for receiving a broadcasting applying signal from a broadcasting control center according to the customer's request, the customer's request is provided through a communication channel as upstream data transfer from at least one customer premise equipment, the method comprising the steps of:
storing multimedia data, the multimedia data are used for propagating through the local TV broadcasting channel;
receiving the broadcasting applying signal from the broadcasting control center, wherein the broadcasting applying signal comprises at least one selected from the group consisting of at least one customer's information, a summary of the multimedia data, and a summary related to the local broadcasting center;
detecting a requested digital multimedia data from a database;
converting the detected digital multimedia data to analog multimedia data;
generating an analog broadcasting signal added caption data, wherein the caption data are displayed on TV within the customer premise equipment; and
propagating the analog broadcasting signal to a plurality of customer premise equipment limited service area through the local TV broadcasting channel according to a broadcasting schedule.

22. A communication system for propagating multimedia data through a local television (TV) broadcasting channel as downstream data transfer to a plurality of customer premise equipment, and for receiving at least one customer's request through the Internet as upstream data transfer from at least one customer premise equipment, said communication system comprising:
a broadcasting control center for receiving at least one customer's request from at least one customer premise equipment, and for transmitting a broadcasting applying signal to the local broadcasting center according to the customer's request; and
at least one of local broadcasting center coupled to said broadcasting control center and said plurality of the customer premise equipment, for propagating multimedia data through the local TV broadcasting channel to the plurality of the customer premise equipment limited service area according to the broadcasting applying signal from the broadcasting control center.

23. A method for propagating multimedia data through a local television (TV) broadcasting channel as downstream data transfer to plurality of customer premise equipment, and for receiving at least one customer's request through the Internet as upstream data transfer from at least one customer premise equipment, the method comprising the steps of:
storing multimedia data in a database of at least one local broadcasting center,
storing a summary of multimedia data in a database of the broadcasting control center, the summary of multimedia data is used for representing multimedia data in local broadcasting centers;
receiving at least one customer's request from the customer premise equipment through the Internet as upstream data transfer;
generating a broadcasting applying signal according to the customer's request, the broadcasting applying signal comprises at least one selected from the group consisting of at least one customer's information, a summary of multimedia data and a summary related to local broadcasting center;
transmitting the broadcasting applying signal to the local broadcasting center according to the customer's request;
detecting desired multimedia data from local broadcasting center's database according to the broadcasting applying signal;
converting the detected digital multimedia data to a analog broadcasting signal; and
propagating the analog broadcasting signal to the plurality of customer premise equipment limited service area according to the customer's request through local TV broadcasting channel as downstream data transfer.

24. A computer-readable medium having stored thereon computer-executable instructions for performing the steps comprising:
storing multimedia data in a database of at least one local broadcasting center,
storing a summary of multimedia data in a database of the broadcasting control center, wherein the summary of multimedia data are used for representing each multimedia data in local broadcasting centers;
receiving at least one customer's request from at least one customer premise equipment through the telephone network as upstream data transfer;
generating a broadcasting applying signal according to the at least one customer's request, wherein the broadcasting applying signal comprises at least one selected from the group consisting of customers' information, a summary of multimedia data, and a summary related to local broadcasting center;
transmitting the broadcasting applying signal to the local broadcasting center coupled to the customer premise equipment according to the customer's request;
detecting desired multimedia data from the local broadcasting center's database according to the broadcasting applying signal;
converting the detected digital multimedia data to analog broadcasting signal; and
propagating the analog broadcasting signal to plurality of customer premise equipment limited service area through the local TV broadcasting channel.

25. A computer-readable medium having stored thereon computer-executable instructions for performing the steps comprising:
storing a summary of multimedia data and a summary related to at least one local broadcasting center, wherein the multimedia data are stored in the at least one local broadcasting center;
receiving at least one customer's request from at least one customer premise equipment through the telephone network as upstream data transfer;
generating a broadcasting applying signal, which is comprised of at least one selected from the group consisting of customer's information, a summary of the multimedia data, and a summary related to the local broadcasting center; and
transmitting the broadcasting applying signal to the local broadcasting center coupled to the customer premise equipment according to the customer's request.

26. A computer-readable medium having stored thereon computer-executable instructions for performing the steps comprising:
storing multimedia data, the multimedia data are used for propagating through the local television (TV) broadcasting channel;
receiving the broadcasting applying signal from the broadcasting control center, wherein the broadcasting applying signal comprises at least one selected from the group consisting of at least one customer's information, a summary of the multimedia data, and a summary related to the local broadcasting center;
detecting a requested digital multimedia data from a database;
converting the detected digital multimedia data to analog multimedia data;
generating an analog broadcasting signal added caption data, wherein the caption data are displayed on TV within the customer premise equipment; and
propagating the analog broadcasting signal to a plurality of customer premise equipment limited service area through the local TV broadcasting channel according to a broadcasting schedule.

27. A computer-readable medium having stored thereon computer-executable instructions for performing the steps comprising:
storing multimedia data in a database of at least one local broadcasting center,
storing a summary of multimedia data in a database of the broadcasting control center, the summary of multimedia data is used for representing multimedia data in local broadcasting centers;
receiving at least one customer's request from the customer premise equipment through the Internet as upstream data transfer;
generating a broadcasting applying signal according to the customer's request, the broadcasting applying signal comprises at least one selected from the group consisting of at least one customer's information, a summary of multimedia data and a summary related to local broadcasting center;
transmitting the broadcasting applying signal to the local broadcasting center according to the customer's request;
detecting desired multimedia data from local broadcasting center's database according to the broadcasting applying signal;
converting the detected digital multimedia data to a analog broadcasting signal; and
propagating the analog broadcasting signal to the plurality of customer premise equipment limited service area according to the customer's request through local TV broadcasting channel as downstream data transfer.
